(19) United States
(12) Patent Application Publication
(10) Pub. No.: US 2023/0389084 A1
(43) Pub. Date: Nov. 30, 2023

(54) INCLUSION OF PREAMBLE GROUP INFORMATION IN THE RA-REPORT

(71) Applicant: Telefonaktiebolaget LM Ericsson (publ), Stockholm (SE)

(72) Inventors: Marco BELLESCHI, Solna (SE); Johan RUNE, Lidingo (SE); Pradeepa RAMACHANDRA, Linköping (SE)

(21) Appl. No.: 18/247,871

(22) PCT Filed: Oct. 22, 2021
(86) PCT No.: PCT/IB2021/059768

§ 371 Date: Apr. 4, 2023

Related U.S. Application Data
(60) Provisional application No. 63/104,449, filed on Oct. 22, 2020.

(51) Int. Cl. H04W 74/08

(52) U.S. Cl. CPC H04W 74/0833

(57) ABSTRACT

A method, network node wireless device for inclusion of preamble group information in a random access (RA) report are disclosed. According to one aspect, a method in a network node includes receiving a report from the WD, the report comprising at least one of: a selection of one of a first preamble group and a second preamble group by the WD; an indication that at least one of a first condition and a second condition is satisfied. The method also includes configuring at least one of a first preamble group and a second preamble group based at least in part on the report received from the WD, the radio interface being configured to transmit an indication of which of the first and second preamble groups are configured.

### FIELD

The present disclosure relates to wireless communications, and in particular, to inclusion of preamble group information in a random access (RA) report.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. WDs are referred to herein as user equipment (UE). Sixth Generation (6G) wireless communication systems are also under development.

Wireless communication systems according to the 3GPP may include one or more of the following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

In LTE, the report of random access channel (RACH) information when a random access procedure is performed may be requested by the network via the WD Information procedure in radio resource control (RRC), in the case where a RACH procedure was successful. That procedure is summarized below, as described in RRC specifications.

The WD information procedure is used by evolved universal terrestrial radio access network (E-UTRAN) to request the WD to report information. Initiation

E-UTRAN initiates the procedure by sending the WDInformationRequest message. E-UTRAN should initiate this procedure only after successful security activation.

### Reception of the UEInformationRequest Message

Upon receiving the WDInformationRequest message, the WD shall, only after successful security activation:

| | |
|---|---|
| 1> | if rach-ReportReq is set to true, set the contents of the rach-Report in the |

WDInformationResponse message as follows:

| 2> | set the numberOfPreamblesSent to indicate the number of preambles sent | |
|---|---|---|
| by MAC for the last successfully completed random access procedure; | | |
| 2> | if contention resolution was not successful as specified in 3GPP TS | |
| 36.321 [6] for at least one of the transmitted preambles for the last successfully | | |
| completed random access procedure: | | |
| | 3> | set the contentionDetected to true; |
| 2> | else: | |
| | 3> | set the contentionDetected to false; |

. . .

| 1> | else: | |
|---|---|---|
| | 2> | submit the WDInformationResponse message to lower layers for |

transmission via SRB1;

### UEInformationRequest

The WDInformationRequest is the command used by E-UTRAN to retrieve information from the WD.
Signaling radio bearer: SRB1;
RLC-SAP: AM;
Logical channel: DCCH;
Direction: E-UTRAN to WD

### UEInformationRequest Message:

| ASN1START | |
|---|---|
| UEInformationRequest-r9 ::= | SEQUENCE |
| { | |
| rrc-TransactionIdentifier | RRC-TransactionIdentifier, |
| criticalExtensions | CHOICE { |
| c1 | |
| CHOICE { | |
| ueInformationRequest-r9 | |
| UEInformationRequest-r9-IEs, | |
| spare3 NULL, spare2 NULL, spare1 NULL | |
| }, | |
| criticalExtensionsFuture | SEQUENCE { } |
| } | |
| } | |
| UEInformationRequest-r9-IEs ::= | SEQUENCE { |
| rach-ReportReq-r9 | BOOLEAN, |
| rlf-ReportReq-r9 | BOOLEAN, |
| nonCriticalExtension | UEInformationRequest- |
| v930-IEs OPTIONAL | |

rach-ReportReq: This field is used to indicate whether the WD shall report information about the random access procedure.

### UEInformationResponse

The WDInformationResponse message is used by the WD to transfer the information requested by the E-UTRAN. Signaling radio bearer: SRB1 or SRB2 (when logged measurement information is included)
RLC-SAP: AM
Logical channel: DCCH
Direction: WD to E-UTRAN

### UEInformationResponse Message

| | |
|---|---|
| -- ASN1START | |
| UEInformationResponse-r9 ::= | SEQUENCE { |
| rrc-TransactionIdentifier | RRC-TransactionIdentifier, |
| criticalExtensions | CHOICE { |

```
    c1
  CHOICE {
      ueInformationResponse-r9
  UEInformationResponse-r9-IEs,
      spare3 NULL, spare2 NULL, spare1 NULL
    },
```

| | |
|---|---|
| criticalExtensionsFuture | SEQUENCE { } |
| } | |
| } | |
| UEInformationResponse-r9-IEs ::= | SEQUENCE { |
| rach-Report-r9 | SEQUENCE |
| { | |
| numberOfPreamblesSent-r9 | |
| NumberOfPreamblesSent-r11, | |
| contentionDetected-r9 | BOOLEAN |
| } | |
| | OPTIONAL, |
| rlf-Report-r9 | RLF-Report- |
| r9 OPTIONAL, | |
| nonCriticalExtension | |
| UEInformationResponse-v930-IEs | OPTIONAL |
| } | |
| NumberOfPreamblesSent-r11 ::= | INTEGER (1..200) |
| -- ASN1STOP | |

In summary, for each RACH procedure, the WD stores the number of preambles sent, which corresponds to the parameter PREAMBLE_TRANSMISSION_COUNTER in medium access control (MAC) specifications (3GPP Technical Standard (TS) 36.321). In the random access procedure in LTE, the WD sends a preamble and waits for a random-access response (RAR) during a pre-configured time window (RAR window). If the RAR does not come within that time, the WD adjusts some preamble transmission parameters (e.g., transmission power) and transmits the preamble again (in what is called a power ramping adjustment). If the procedure is successful, at the n-th transmission the RAR will be sent. The number n is what would be provided in the RACH report, so the network knows how many times the WD needed to ramp the power before the procedure was successful.

The random-access procedure, and specifically the meaning of the PREAMBLE_TRANSMISSION_COUNTER is shown below, as described in the MAC specifications. First, during the initialization the counter is set to 1. Then, at the first attempt, for example according to the preamble transmission in section 5.3.1 of 3GPP TS 36.321, the WD shall set the preamble received target power, i.e., the expected power in the RACH receiver at the LTE base station (eNB), to the initial transmission power (parameter provided by the eNB, e.g., via System Information Block 2 (SIB2) in LTE). These values may range from −120 dBm to −90 dBm, and are provided as part of the Power Ramping Parameters. Note that this may also be a parameter to be optimized later (too large a value may lead to a high RACH success rate, but could also create unnecessary uplink (UL) interference, which is problematic, especially in high load scenarios).

As shown below, the PREAMBLE_RECEIVED_TARGET_POWER will be in this first attempt the preambleInitialReceivedTargetPower+DELTA_PREAMBLE (offset depending on the preamble format that has been configured by the network in prach-ConfigIndex, ranging from −3 dB to 8 dB).

Then, if no response is received within the configured RAR time window, another parameter to possibly optimize, PREAMBLE_TRANSMISSION_COUNTER is incremented by 1. Then, whether the number of increments has reached its maximum value or not is determined. The maximum value is a configurable parameter that may be optimized.

Assuming the WD may still perform preamble re-transmission, power ramping occurs and the new preamble transmission power is incremented by a power ramping step, which is also a configurable parameter. The transmission power in this second attempt will then be:

PREAMBLE RECEIVED TARGET POWER=preambleInitialReceivedTargetPower+DELTA_PREAMBLE+1*powerRampingStep

The parameter powerRampingStep may be 0 dB, 2 dB, 4 dB or 6 dB. Power ramping parameters as broadcasted in SIB2 as shown below.

| | |
|---|---|
| PowerRampingParameters ::= | SEQUENCE { |
| powerRampingStep | ENUMERATED |

```
{dB0, dB2,dB4, dB6},
  preambleInitialReceivedTargetPowerENUMERATED {
  dBm-120, dBm-118, dBm-116, dBm-114, dBm-112,
  dBm-110, dBm-108, dBm-106, dBm-104, dBm-102,
dBm-100, dBm-98, dBm-96, dBm-94,
dBm-92, dBm-90}
}.
```

At the (N+1)-th attempt:

PREAMBLE RECEIVED TARGET POWER=preambleInitialReceivedTargetPower+DELTA PREAMBLE+N*powerRampingStep

This preamble power ramping procedure, in case of multiple preamble transmission attempts, is shown below as described in the MAC specifications (in 3GPP TS 36.321):

The Random Access procedure shall be performed as follows:
Flush the Msg3 buffer;
set the PREAMBLE_TRANSMISSION_COUNTER to 1;
set the backoff parameter value to 0 ms;
for the RN, suspend any RN subframe configuration;
proceed to the selection of the Random Access Resource (see subclause 5.1.2of 3GPP TS 36.321).

As in LTE, the random access procedure is described in the NR medium access control (MAC) specifications and parameters are configured by RRC, e.g., in system information or handover (RRCReconfiguration with reconfigurationWithSync). Random access is triggered in many different scenarios, for example, when the WD is in RRC_IDLE or RRC_INACTIVE and wants to access a cell that the WD is camping on (i.e., transition to RRC_CONNECTED).

In NR, the RACH configuration is broadcasted in SIB1, as part of the servingCellConfigCommon (with both downlink (DL) and uplink (UL) configurations), where the RACH configuration is within the uplinkConfigCommon. The exact RACH parameters are within what is called initialUplinkBWP. This is the part of the UL frequency that the WD shall access and search for RACH resources.

Below, the RACH configuration is shown, focusing primarily on parameters related to the preamble power ramping functionality, i.e., power ramping step and initial power ramping, as shown above for LTE.

### RACH-ConfigGeneric Information Element (IE)

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER |

(0..maxNrofPhysicalResourceBlocks−1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, |
| | n7, n8, n10, |

n20, n50, n100, n200},

| | |
|---|---|
| powerRampingStep | ENUMERATED {dB0, dB2, dB4, |
| | dB6}, |
| ra-Response Window | ENUMERATED {s11, s12, s14, s18, |

s110, s120, s140, s180},
}
-- TAG-RACH-CONFIGGENERIC-STOP
-- ASN1STOP

RACH-ConfigGeneric field descriptions

msg1-FDM
The number of PRACH transmission occasions FDMed in one time
instance. (see 3GPP TS 38.211 [16], clause 6.3.3.2)
msg1-FrequencyStart
Offset of lowest PRACH transmission occasion in frequency domain with
respective to PRB 0. The value is configured so that the
corresponding RACH resource is entirely within the bandwidth
of the UL BWP. (see 3GPP TS 38.211 [16], clause 6.3.3.2).
powerRampingStep
Power ramping steps for PRACH (see 3GPP TS 38.321 [3], 5.1.3).
prach-ConfigurationIndex
PRACH configuration index. For prach-ConfigurationIndex configured
under beamFailureRecovery-Config, the prach-ConfigurationIndex can
only correspond to the short preamble format, (see 3GPP TS
38.211 [16], clause 6.3.3.2).
preambleReceivedTargetPower
The target power level at the network receiver side (see 3GPP
TS 38.213 [13], clause 7.4, 3GPP TS 38.321 [3],
clauses 5.1.2, 5.1.3). Only multiples of 2 dBm may be
chosen (e.g. −202, −200, −198, . . .).
preambleTransMax
Max number of RA preamble transmission performed before declaring
a failure (see 3GPP TS 38.321 [3], clauses 5.1.4, 5.1.5).
ra-ResponseWindow
Msg2 (RAR) window length in number of slots. The network
configures a value lower than or equal to 10 ms (see 3GPP
TS 38.321 [3], clause 5.1.4). WD ignores the field if
included in SCellConfig.
zeroCorrelationZoneConfig
N-CS configuration, see Table 6.3.3.1-5 in 3GPP TS 38.211 [16]

### RACH-ConfigCommon Information Element (IE)

-- ASNISTOP
-- TAG-RACH-CONFIGCOMMON-START

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) OPTIONAL, -- Need |

S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| sixteen | INTEGER (1..4) |
| } | |
| OPTIONAL, -- Need M | |
| groupBconfigured | SEQUENCE { |
| ra-Msg3SizeGroupA | ENUMERATED {b56, b144, b208, b256, |
| b282, b480, b640, | |
| | b800, b1000, b72, spare6, spare5,spare4, |
| spare3, spare2, spare1}, | |
| messagePowerOffsetGroupB | ENUMERATED { minus infinity, dB0, |

dB5, dB8, dB10, dB12, dB15, dB18},

| | |
|---|---|
| numberOfRA-PreamblesGroupA | INTEGER (1..64) |
| } | |
| OPTIONAL, -- Need R | |
| ra-ContentionResolutionTimer | ENUMERATED {sf8, sf16, sf24, sf32, |
| sf40, sf48, sf56, sf64}, | |
| rsrp-ThresholdSSB | RSRP-Range |
| OPTIONAL, -- Need R | |
| rsrp-ThresholdSSB-SUL | RSRP-Range |
| OPTIONAL, -- Cond SUL | |
| prach-RootSequenceIndex | CHOICE { |
| 1839 | INTEGER (0..837), |
| 1139 | INTEGER (0..137) |
| }, | |
| msg1-SubcarrierSpacing | SubcarrierSpacing |
| OPTIONAL, -- Cond L139 | |
| restrictedSetConfig | ENUMERATED { unrestrictedSet, |

restrictedSetTypeA, restrictedSetTypeB},

| | |
|---|---|
| msg3-transformPrecoder | ENUMERATED { enabled} |

OPTIONAL, -- Need R
}
-- TAG-RACH-CONFIGCOMMON-STOP
-- ASN1STOP

RACH-ConfigCommon field descriptions

messagePowerOffsetGroupB
Threshold for preamble selection. Value in dB. Value minus infinity
corresponds to −infinity. Value dB0 corresponds to 0 dB, dB5
corresponds to 5 dB and so on. (see 3GPP TS 38.321 [3],
clause 5.1.2)
msg1-SubcarrierSpacing
Subcarrier spacing of PRACH (see 3GPP TS 38.211 [16],
clause 5.3.2). Only the values 15 or 30 kHz (<6 GHz), 60 or
120 kHz (>6 GHz) are applicable (see 3GPP TS 38.211 [16],
section FFS_Section). If absent, the WD applies the SCS as derived
from the prach-ConfigurationIndex in RACH-ConfigGeneric
(see tables Table 6.3.3.1-1 and Table 6.3.3.2-2, 3GPP TS 38.211
[16]). The value also applies to contention free random
access (RACH-ConfigDedicated), to SI-request and to contention-
based beam failure recovery (CB-BFR). But it does not apply for
contention free beam failure recovery (CF-BFR) (see
BeamFailureRecoveryConfig).
msg3-transformPrecoder
Enables the transform precoder for Msg3 transmission. If the field
is absent, the WD disables the transformer precoder (see 3GPP TS
38.213 [13], clause 8.3)
numberOfRA-PreamblesGroupA
The number of CB preambles per SSB in group A. This determines
implicitly the number of CB preambles per SSB available in group B.
(see 3GPP TS 38.321 [3], clause 5.1.1). The setting should be
consistent with the setting of ssb-perRACH-
OccasionAndCB-PreamblesPerSSB.
prach-RootSequenceIndex
PRACH root sequence index (see 3GPP TS 38.211 [16], clause 6.3.3.1).
The value range depends on whether L = 839 or L = 139. The
short/long preamble format indicated in this IE should be consistent
with the one indicated in prach-ConfigurationIndex in the
RACH-ConfigDedicated (if configured).
ra-ContentionResolutionTimer
The initial value for the contention resolution timer (see 3GPP TS
38.321 [3], clause 5.1.5). Value sf8 corresponds to 8 subframes,
value sf16 corresponds to 16 subframes, and so on.
ra-Msg3SizeGroupA
Transport Blocks size threshold in bit below which the WD shall use a
contention-based RA preamble of group A. (see 3GPP TS 38.321 [3],
clause 5.1.2)
rach-ConfigGeneric
Generic RACH parameters
restrictedSetConfig
Configuration of an unrestricted set or one of two types of restricted
sets, see 3GPP TS 38.211 [16], clause 6.3.3.1.
rsrp-ThresholdSSB
UE may select the SS block and corresponding PRACH resource for
path-loss estimation and (re)transmission based on SS blocks
that satisfy the threshold (see 3GPP TS 38.213 [13])
rsrp-ThresholdSSB-SUL
The WD selects SUL carrier to perform random access based on this
threshold (see 3GPP TS 38.321 [3], clause 5.1.1). The value
applies to all the BWPs.
ssb-perRACH-OccasionAndCB-PreamblesPerSSB
The meaning of this field is twofold: the CHOICE conveys the
information about the number of SSBs per RACH occasion (L1
parameter ‘SSB-per-rach-occasion’). Value oneEight
corresponds to one SSB associated with 8 RACH occasions, value
oneFourth corresponds to one SSB associated with 4 RACH occasions,
and so on. The ENUMERATED part indicates the number of Contention
Based preambles per SSB (L1 parameter ‘CB-preambles-per-SSB’).
Value n4 corresponds to 4 Contention Based preambles per SSB,
value n8 corresponds to 8 Contention Based preambles per SSB,
and so on. The total number of CB preambles in a RACH occasion is
given by CB-preambles-per-SSB * max(1, SSB-per-rach-occasion).
totalNumberOfRA-Preambles
Total number of preambles used for contention based and contention
free random access in the RACH resources defined in RACH-
ConfigCommon, excluding preambles used for other purposes
(e.g. for SI request). If the field is absent, the all 64
preambles are available for RA. The setting should be
consistent with the setting of ssb-perRACH-OccasionAndCB-
PreamblesPerSSB, i.e. it should be a multiple of the number
of SSBs per RACH occasion.

### 4-Step Random Access (RA) Procedure in New Radio (NR)

A 4-step approach is used for the random access procedure, as shown in FIG. 1. In this approach, the WD detects a synchronization signal (SS) and decodes the broadcasted system information, followed by transmitting a PRACH preamble (message 1) in the uplink. The NR base station (gNB) replies with a RAR (Random Access Response, message 2). The WD then transmits a WD identification (message 3) on PUSCH.

In NR, the time and frequency resource on which a PRACH preamble is transmitted is defined as a PRACH occasion.

In this disclosure, the PRACH occasion is also called RACH occasion, or RA occasion, or in short RO. The RO used for the transmission of the preambles in 2-step RA is called 2-step RO, while the RO used for the transmission of the preambles in 4-step RA is called 4-step RO.

The time resources and preamble format for PRACH transmission is configured by a PRACH configuration index, which indicates a row in a PRACH configuration table specified in 3GPP TS 38.211, Tables 6.3.3.2-2, 6.3.3.2-3, 6.3.3.2-4 for frequency range 1 (FR1) paired spectrum, FR1 unpaired spectrum and FR2 with unpaired spectrum, respectively.

Part of the Table 6.3.3.2-3 for FR1 unpaired spectrum for PRACH preamble format 0 is copied in Table 1 below, where the value of x indicates the PRACH configuration period in number of system frames. The value of y indicates the system frame within each PRACH configuration period on which the PRACH occasions are configured. For instance, y set to 0 indicates PRACH occasions only configured in the first frame of each PRACH configuration period. The values in the column “subframe number” specifies on which subframes are configured with a PRACH occasion. The values in the column “starting symbol” is the symbol index.

In time division duplexing (TDD), semi-statically configured DL parts and/or actually transmitted synchronization signal blocks (SSBs) can override and invalidate some time-domain PRACH occasions defined in the PRACH configuration table. More specifically, PRACH occasions in the UL part are always valid, and a PRACH occasion within the X part is valid as long as it does not precede or collide with an SSB in the RACH slot and it is at least N symbols after the DL part and the last symbol of an SSB. N is 0 or 2 depending on PRACH format and subcarrier spacing.

TABLE 1
PRACH configuration for preamble format 0 for FR1 unpaired spectrum

| | | | | | | | Nₜ^{RA,slot}, | |
|---|---|---|---|---|---|---|---|---|
| | | | | | | | number | |
| | | | | | | | of | |
| | | | | | | Number | time- | |
| | | | | | | of | domain | |
| | | | | | | PRACH | PRACH | |
| | | | | | | slots | occasions | |
| PRACH | | | | | | within | within a | N_{dur}^{RA}, |
| Configuration | Preamble | n_{SFN} mod x = y | | Subframe | Starting | a sub- | PRACH | PRACH |
| Index | format | x | y | number | symbol | frame | slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | — | — | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, | 0 | — | — | 0 |
| | | | | 8, 9 | | | | |
| 25 | 0 | 1 | 0 | 6, 7, | 0 | — | — | 0 |
| | | | | 8, 9 | | | | |
| 26 | 0 | 1 | 0 | 1, 4, | 0 | — | — | 0 |
| | | | | 6, 9 | | | | |
| 27 | 0 | 1 | 0 | 1, 3, 5, | 0 | — | — | 0 |
| | | | | 7, 9 | | | | |

In the frequency domain, NR supports multiple frequency-multiplexed PRACH occasions on the same time-domain PRACH occasion. This is mainly motivated by the support of analog beam sweeping in NR such that the PRACH occasions associated to one SSB are configured at the same time instance but different frequency locations. The number of PRACH occasions that are frequency division multiplexed in one time domain PRACH occasion, can be 1, 2, 4, or 8. FIG. 2 gives an example of the PRACH occasion configuration in NR.

In NR 3GPP Rel-15, there are up to 64 sequences that can be used as random-access preambles per PRACH occasion in each cell. The RRC parameter totalNumberOfRA-Preambles determines how many of these 64 sequences are used as random-access preambles per PRACH occasion in each cell. The 64 sequences are configured by first including all the available cyclic shifts of a root Zadoff-Chu sequence, and second configuring in the order of increasing root index, until 64 preambles have been generated for the PRACH occasion.

### 3GPP NR Rel-15 Association Between SSB and PRACH Occasion

3GPP NR Rel-15 supports one-to-one, one-to-many, and many-to-one association between SSB and PRACH Occasions, as illustrated in the examples shown in FIG. 3 and FIG. 4.

When WD detects one best SSB beam, a preamble in the set of one or more preambles mapped to this SSB will be selected for the random access, then when the gNB detects the preamble, the best SSB beam for this WD is known indirectly so that best beams can be used for transmitting signals to or receiving signals from this WD.

The preambles associated to each SSB are configured by the two RRC parameters in the RACH-ConfigCommon: ssb-perRACH-OccasionAndCB-PreamblesPerSSB and totalNumberOfRA-Preambles.

A detailed mapping rule is specified in 3GPP TS 38.213, section 8.1, as follows:

A WD is provided a number of SS/PBCH blocks associated with one PRACH occasion and a number of contention based preambles per SS/PBCH block per valid PRACH occasion by ssb-perRACH-OccasionAndCB-PreamblesPerSSB. If

A UE is provided a number N of SS/PBCH blocks associated with one PRACH occasion and a number R of contention based preambles per SS/PBCH block per valid PRACH occasion by ssb-perRACH-OccasionAndCB-PreamblesPerSSB. If N<1, one SS/PBCH block is mapped to 1/N consecutive valid PRACH occasions and R contention based preambles with consecutive indices associated with the SS/PBCH block per valid PRACH occasion start from preamble index 0. If N≥1, R contention based preambles with consecutive indices associated with SS/PBCH block n, 0≤n≤N−1, per valid PRACH occasion start from preamble index n·N_{preamble}^{total}/N where N_{preamble}^{total} is provided by totalNumberOfRA-Preambles and is an integer multiple of N.

In other words, the mapping between SSB and preambles is done by consecutively associating M preambles to each SSB, where M=N_{preamble}^{total}/N, and as illustrated in FIG. 5 the preambles are taken in the following order
First, in increasing order of preamble indices within a single PRACH occasion;
Second, in increasing order of frequency resource indices for frequency multiplexed PRACH occasions; and
Third, in increasing order of time.

For each SSB, the associated preambles per PRACH occasion are further divided into two sets for CBRA and CFRA. The number of CB preambles per SSB per PRACH occasion is signaled by the RRC parameter #CB-preambles-per-SSB. Preamble indices for CBRA and CFRA are mapped consecutively for one SSB in one PRACH occasion, as shown in FIG. 6.

A 2-step RACH work item has been considered in a RAN1 #82 plenary meeting.

An example of completing the initial access in only two steps is illustrated in FIG. 7.
Step 1: WD sends a message A (abbreviated “MsgA” or “msgA”—these two abbreviations are used interchangeably in this document) including random access preamble together with higher layer data such as RRC connection request possibly with some small payload on PUSCH;
Step 2: The gNB sends RAR (actually called message B (abbreviated “MsgB” or “msgB”—these two abbreviations are used interchangeably in this document)) including WD identifier assignment, timing advance information, and contention resolution message etc.

The RACH occasions for 2-step RACH can be either separately configured (also known as Type-2 random access procedure with separate configuration of PRACH occasions with Type-1 random access procedure) or shared with 4-step RACH (also known as Type-2 random access procedure with common configuration of PRACH occasions with Type-1 random access procedure), in which case different set of preamble IDs will be used.

For Type-2 random access procedure with common configuration of PRACH occasions with Type-1 random access procedure, a WD is provided a number N of SS/PBCH blocks associated with one PRACH occasion by ssb-perRACH-OccasionAndCB-PreamblesPerSSB and a number Q of contention based preambles per SS/PBCH block per valid PRACH occasion by MsgA-CB-PreamblesPerSSB. The PRACH transmission can be on a subset of PRACH occasions associated with a same SS/PBCH block index for a WD provided with a PRACH mask index by MsgA-ssb-sharedRO-MaskIndex. An example of the SSB to RO mapping and the preamble allocation is shown in FIG. 8. Note that only one preamble group is assumed in this example. FIG. 8 illustrates the associated preambles for CBRA and CFRA per SSB per PRACH occasion, when ROs for 2-step RACH and 4-step RACH are shared.

For Type-2 random access procedure with separate configuration of PRACH occasions with Type-1 random access procedure, a WD is provided a number N of SS/PBCH blocks associated with one PRACH occasion and a number R of contention based preambles per SS/PBCH block per valid PRACH occasion by ssb-perRACH-OccasionAndCB-PreamblesPerSSB-MsgA when provided; otherwise, by ssb-perRACH-OccasionAndCB-PreamblesPerSSB. Since the SSB to RO mapping and the preamble allocation are independently configured, the example provided for 4-step RACH in FIG. 8 is also valid for this case of 2-step RACH except that the parameters are separately configured for 2-step RACH.

A PUSCH occasion (PO) is defined as the time frequency resource used for one PUSCH transmission. For one MsgA PUSCH occasion, one or more demodulation reference signal (DMRS) resources can be configured, one of which will be selected for each PUSCH transmission within the PUSCH occasion. The term PUSCH resource unit (PRU) is used herein to define a PUSCH occasion with one DMRS resource.

A set of PUSCH occasions are configured per MsgA PUSCH configuration which are relative to and mapped by a group of preambles in a set of ROs in one PRACH slot. A mapping between one or multiple PRACH preambles and a PUSCH occasion associated with a DMRS resource is according to the mapping order as described below.

Each consecutive number of N_{preamble} preamble indices from valid PRACH occasions in a PRACH slot are configured:
first, in increasing order of preamble indices within a single PRACH occasion;
second, in increasing order of frequency resource indices for frequency multiplexed PRACH occasions;
third, in increasing order of time resource indices for time multiplexed PRACH occasions within a PRACH slot; and
   are mapped to a valid PUSCH occasion and the associated DMRS resource:
first, in increasing order of frequency resource indices f_{id} for frequency multiplexed PUSCH occasions;
second, in increasing order of DMRS resource indices within a PUSCH occasion, where a DMRS resource index DMRS_{id} is determined first in an ascending order of a DMRS port index and second in an ascending order of a DMRS sequence index [3GPP TS 38.211];
third, in increasing order of time resource indices t_{id} for time multiplexed PUSCH occasions within a PUSCH slot; and
fourth, in increasing order of indices for Nₛ PUSCH slots;
   where N_{preamble}=ceil(T_{preamble}/T_{PUSCH}), T_{preamble} is a total number of valid PRACH occasions per association pattern period multiplied by the number of preambles per valid PRACH occasion provided by MsgA-PUSCH-PreambleGroup, and T_{PUSCH} is a total number of valid PUSCH occasions per PUSCH configuration per association pattern period multiplied by the number of DMRS resource indices per valid PUSCH occasion provided by MsgA-DMRS-Config.

An example CFRA procedure with 4-step RA type (top) and 2-step RA type (bottom) is illustrated in FIG. 9. In FIG. 9, the network assigns a preamble for CFRA in 4-step RACH or a preamble and PUSCH for CFRA in 2-step RACH. The network does not configure CFRA resources for 4-step and 2-step RA types at the same time for a bandwidth part (BWP). CFRA with 2-step RA type is only supported for handover.

The Msg1 of 4-step includes only a preamble on PRACH, while the MSGA of the 2-step RA type includes a preamble on PRACH and a payload on PUSCH. After Msg1 transmission or MSGA transmission, WD monitors for a response from the network within a configured window. For CFRA, upon receiving the network response, the WD ends the random access procedure.

For CFRA with 2-step RA type, a MsgA-CFRA-PUSCH similar to what is used for CBRA with 2-step RA type is included in the RACH-ConfigDedicated IE.

| | |
|---|---|
| RACH-ConfigDedicated ::= | SEQUENCE { |
| cfra | CFRA |

OPTIONAL, -- Need S

| | |
|---|---|
| ra-Prioritization | OPTIONAL, -- |

```
Need N
  ...,
  [[
```

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

OPTIONAL -- Need N
]]
}

| | |
|---|---|
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, |

oneHalf, one, two, four, eight, sixteen}
OPTIONAL -- Cond SSB-CFRA
}
OPTIONAL, -- Need S

| | |
|---|---|
| resources | CHOICE { |
| ssb | SEQUENCE { |
| ssb-ResourceList | SEQUENCE (SIZE(1..maxRA-SSB- |

Resources)) OF CFRA-SSB-Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS- |

Resources)) OF CFRA-CSIRS-Resource,

| | |
|---|---|
| rsrp-ThresholdCSI-RS | RSRP-Range |

```
    }
  },
  ....
  [[
  totalNumberOfRA-Preambles INTEGER (1..63)
OPTIONAL -- Cond Occasions
  ]]
}
```

| | |
|---|---|
| CFRA-TwoStep-r16 ::= | SEQUENCE { |
| occasionsTwoStepRA-r16 | SEQUENCE { |
| rach-ConfigGenericTwoStepRA-r16 | RACH-ConfigGeneric, |
| ssb-PerRACH-OccasionTwoStepRA-r16 | ENUMERATED {oneEighth, |

oneFourth, oneHalf, one,

| | |
|---|---|
| | two, four, eight, sixteen} |
| OPTIONAL -- Cond SSB-CFRA | |
| } | |
| - Need S | |
| MsgA-CFRA-PUSCH-r16 | MsgA-PUSCH-Config-r16 |
| resourcesTwoStep-r16 | CHOICE { |
| ssb | SEQUENCE { |
| ssb-ResourceList | SEQUENCE (SIZE(1..maxRA-SSB- |
| Resources)) OF CFRA-SSB-Resource, | |
| ra-ssb-OccasionMaskIndex | INTEGER (0..15) |
| }, | |
| csirs | SEQUENCE { |
| csirs-ResourceList | SEQUENCE (SIZE(1..maxRA-CSIRS- |
| Resources)) OF CFRA-CSIRS-Resource, | |
| rsrp-ThresholdCSI-RS | RSRP-Range |
| } | |
| }, | |

totalNumberOfTwoStepRA-Preambles-r16 INTEGER (1..62),

| | |
|---|---|
| ... | |
| } | |
| CFRA-SSB-Resource ::= | SEQUENCE { |
| ssb | SSB-Index, |
| ra-PreambleIndex | INTEGER (0..63), |
| ... | |
| } | |
| CFRA-CSIRS-Resource ::= | SEQUENCE { |
| csi-RS | CSI-RS-Index, |
| ra-OccasionList | SEQUENCE (SIZE(1..maxRA- |

OccasionsPerCSIRS)) OF INTEGER (0..maxRA-Occasions−1),

| | |
|---|---|
| ra-PreambleIndex | INTEGER (0..63), |
| ... | |
| } | |
| -- TAG-RACH-CONFIGDEDICATED-STOP | |
| -- ASNISTOP | |
| -- ASN1START | |
| -- TAG-MSGA-PUSCH-CONFIG-START | |
| MsgA-PUSCH-Config-r16 ::= | SEQUENCE { |
| MsgA-PUSCH-ResourceList-r16 | SEQUENCE (SIZE(1..2)) OF |
| MsgA-PUSCH-Resource-r16 | OPTIONAL, -- Cond InitialBWPConfig |
| MsgA-TransmformPrecoder-r16 | ENUMERATED {enabled, |
| disabled} | OPTIONAL, -- Need S |
| MsgA-DataScramblingIndex-r16 | INTEGER (0..1023) |
| OPTIONAL, -- Need S | |
| MsgA-DeltaPreamble-r16 | INTEGER (−1..6) |
| OPTIONAL -- Need S | |
| } | |
| MsgA-PUSCH-Resource-r16 ::= | SEQUENCE { |
| MsgA-PUSCH-PreambleGroup-r16 | ENUMERATED {groupA, |
| groupB} | OPTIONAL, -- Need S |
| MsgA-MCS-r16 | INTEGER (0..15), |
| nrofSlotsMsgA-PUSCH-r16 | INTEGER (1..4), |
| nrofMsgA-PO-PerSlot-r16 | ENUMERATED {one, two, three, |
| six}, | |
| MsgA-PUSCH-TimeDomainOffset-r16 | INTEGER (1..32), |
| MsgA-PUSCH-TimeDomainAllocation-r16 | INTEGER (1..maxNrofUL- |
| Allocations) | OPTIONAL, -- Need S |
| startSymbolAndLengthMsgA-PO-r16 | INTEGER (0..127) |
| OPTIONAL, -- Need S | |
| mappingTypeMsgA-PUSCH-r16 | ENUMERATED {typeA, |
| typeB} | OPTIONAL, -- Need S |
| guardPeriodMsgA-PUSCH-r16 | INTEGER (0..3) |
| OPTIONAL, -- Need R | |
| guardBandMsgA-PUSCH-r16 | INTEGER (0..1), |
| frequencyStartMsgA-PUSCH-r16 | INTEGER |
| (0..maxNrofPhysicalResourceBlocks−1), | |
| nrofPRBs-PerMsgA-PO-r16 | INTEGER (1..32), |
| nrofMsgA-PO-FDM-r16 | ENUMERATED {one, two, four, |
| eight}, | |
| MsgA-IntraSlotFrequencyHopping-r16 | ENUMERATED {enabled} |
| OPTIONAL, -- Need R | |
| MsgA-HoppingBits-r16 | BIT STRING (SIZE(2)) |
| OPTIONAL, -- Need R | |
| MsgA-DMRS-Config-r16 | MsgA-DMRS-Config-r16, |
| nrofDMRS-Sequences-r16 | INTEGER (1..2), |
| MsgA-Alpha-r16 | ENUMERATED {alpha0, alpha04, |
| alpha05, alpha06, | |
| | alpha07, alpha08, alpha09, alpha1} |
| OPTIONAL, -- Need S | |
| interlaceIndexFirstPO-MsgA-PUSCH-r16 | INTEGER (1..10) |
| OPTIONAL, -- Need R | |
| nrofInterlacesPerMsgA-PO-r16 | INTEGER (1..10) |
| OPTIONAL, -- Need R | |
| ... | |
| } | |
| MsgA-DMRS-Config-r16 ::= | SEQUENCE { |
| MsgA-DMRS-AdditionalPosition-r16 | ENUMERATED {pos0, pos1, |
| pos3} | OPTIONAL, -- Need S |
| MsgA-MaxLength-r16 | ENUMERATED {len2} |
| OPTIONAL, -- Need S | |
| MsgA-PUSCH-DMRS-CDM-Group-r16 | INTEGER (0..1) |
| OPTIONAL, -- Need S | |
| MsgA-PUSCH-NrofPorts-r16 | INTEGER (0..1) |
| OPTIONAL, -- Need S | |
| MsgA-ScramblingID0-r16 | INTEGER (0..65536) |
| OPTIONAL, -- Need S | |
| MsgA-ScramblingID1-r16 | INTEGER (0..65536) |
| OPTIONAL -- Need S | |
| } | |
| -- TAG-MSGA-PUSCH-CONFIG-STOP | |
| -- ASNISTOP | |

The WD transmits PUSCH (message 3) after receiving a timing advance command in the RAR, allowing the PUSCH to be received with a timing accuracy within the cyclic prefix. Without this timing advance, a very large cyclic prefix (CP) would be needed in order to be able to demodulate and detect the PUSCH, unless the system is applied in a cell with very small distance between WD and eNB. Since NR will also support larger cells with a need for providing a timing advance to the WD the 4-step approach is needed for random access procedure. In LTE, the RACH report to assist the network to perform RACH optimization, contains the number of preamble transmissions until the procedure succeeds. It is also clear what has happened at the WD between the first transmission and the last transmission until the procedure was considered successful: the WD applied power ramping with a configured step and transmitted the preamble once more.

As in LTE, a similar counter PREAMBLE TRANSMISSION COUNTER that assists the WD to perform power ramping, sort of RACH state variable, also exists in NR. Also as in LTE, during initialization, that counter is set to 1, so that the initial transmission power for the selected preamble is PREAMBLE_RECEIVED_TARGET_POWER=preambleReceivedTargetPower+DELTA_PREAMBLE. This is just like in LTE, where in the first attempt the transmission power is just the initial transmission power configured by the network+a specified offset which depends on the selected preamble.

Also as in LTE, if no response is received within the configured RAR time window, PREAMBLE_TRANSMISSION_COUNTER is incremented by 1. Then, it is checked if the number of increments has reached its maximum value or not (also a configurable parameter that could be optimized).

In NR, random access resource selection should be performed within a cell depending on measurements performed on SSBs (synchronization signal blocks) or channel state information reference signals (CSI-RS s). A cell in NR is basically defined by a set of these SSBs that may be transmitted in 1 (typical implementation for lower frequencies e.g. below 6GHz) or multiple downlink beams (typical implementation for lower frequencies e.g. below 6GHz). For the same cell, these SSBs carry the same physical cell identifier (PCI) and a master information block (MIB). For standalone operation, i.e., to support WDs camping on an NR cell, the SSBs also carry in SIB1 the RACH configuration, which includes a mapping between the detected SSB covering the WD at a given point in time and the PRACH configuration (e.g. time, frequency, preamble, etc.) to be used. For that, each of these beams may transmit its own SSB which may be distinguished by an SSB index.

The mapping between RACH resources and SSBs (or CSI-RS) is also provided as part of the RACH configuration (in RACH-ConfigCommon). Two parameters are relevant here:
#SSBs-per-PRACH-occasion: ⅛, ¼, ½, 1, 2, 8 or 16, which represents the number of SSBs per RACH occasion; and
#CB-preambles-per-SSB preambles to each SS-block: within a RACH occasion, how many preambles are allocated.

With reference to FIGS. 11 and 12, As a first example, if the number of SSBs per RACH occasion is 1, and if the WD is under the coverage of a specific SSB, e.g., SSB index 2, there will be a RACH occasion for that SSB index 2. If the WD moves and is now under the coverage of another specific SSB, e.g., SSB index 5, there will be another RACH occasion for that SSB index 5, i.e., each SSB detected by a given WD would have its own RACH occasion. Hence, at the network side, upon detecting a preamble in a particular RACH occasion the network knows exactly which SSB the WD has selected and, consequently, which downlink beam is covering the WD, so that the network can continue the downlink transmission, e.g., RAR, etc. That factor 1 is an indication that each SSB has its own RACH resource, i.e., a preamble detected there indicates to the network which SSB the WD has selected, i.e., which downlink (DL) beam the network should use to communicate with the WD, such as the one to send the RAR.

Note that each SS-block typically maps to multiple preambles (different cyclic shifts and Zadoff-Chu roots) within a PRACH occasion, so that it is possible to multiplex different WDs in the same RACH occasions since they may be under the coverage of the same SSB. In a second example, shown below, the number of SSBs per RACH occasion is 2. Hence, a preamble received in that RACH occasion indicated to the network that one of the two beams are being selected by the WD. So either the network has means via implementation to distinguish these two beams and/or should perform a beam sweeping in the downlink by transmitting the RAR in both beams, either simultaneously or, transmitting in one beam, waiting for a response from the WD, and if absent, transmit in the other beam.

Assuming now that in the first attempt the WD has selected an SSB (based on measurements performed in that cell), then WD has transmitted with initial power a selected preamble associated to the PRACH resource mapped to the selected SSB, and it has not received a RAR within the RAR time window. According to the specifications, the WD may still perform preamble re-transmission (i.e., maximum number of allowed transmissions not reached).

As in LTE, at every preamble retransmission attempt, the WD may assume the same SSB as the previous attempt and perform power ramping similar to LTE. A maximum number of attempts is also defined in NR, which is also controlled by the parameter PREAMBLE_TRANSMISSION_COUNTER.

On the other hand, different from LTE, in NR, at every preamble retransmission attempt, the WD may alternatively select a different SSB, as long as that new SSB has an acceptable quality (i.e., its measurements are above a configurable threshold). In that case, when a new SSB (or, in more general term, a new beam) is selected, the WD does not perform power ramping, but transmits the preamble with the same previously transmitted power (i.e., WD shall not re-initiate the power to the initial power transmission). An example of this is shown in FIG. 10.

For that reason, a new variable is defined in the NR MAC specifications (3GPP TS 38.321) called PREAMBLE_POWER_RAMPING_COUNTER, in case the same beam is selected at a retransmission. At the same time, the previous LTE variable still exists (PREAMBLE_TRANSMISSION_COUNTER), so that the total number of attempts is still limited, regardless if the WD performs at each attempt SSB/beam re-selection or power ramping.

Hence, if the initial preamble transmission, e.g., associated to SSB-2, does not succeed, and the WD selects the same SSB/beam, then PREAMBLE_POWER_RAMPING_COUNTER is incremented (i.e., set to 2 in this second attempt) and the transmission power will be:

PREAMBLE RECEIVED TARGET POWER=preambleReceivedTargetPower+DELTA PREAMBLE+1*PREAMBLE POWER RAMPING STEP;
Else, if instead the WD selects a different SSB/beam, the PREAMBLE_POWER_RAMPING_COUNTER is not incremented (i.e. remains 1) and the transmission power will be as in the first transmission:

PREAMBLE RECEIVED TARGET POWER=preambleReceivedTargetPower+DELTA PREAMBLE;

That preamble power ramping procedure, in case of multiple preamble transmission attempts, is shown below as described in the MAC specifications (3GPP TS 38.321):

When the Random Access procedure is initiated on a Serving Cell, the MAC entity shall:

1> flush the Msg3 buffer;
1> set the PREAMBLE_TRANSMISSION_COUNTER to 1;
1> set the PREAMBLE_POWER_RAMPING_COUNTER to 1;
1> set PREAMBLE_POWER_RAMPING_STEP to powerRampingStep;
1> set SCALING_FACTOR_BI to 1;
1> if the Random Access procedure was initiated for beam failure
recovery (as specified in subclause 5.17); and
1> if beamFailureRecoveryConfig is configured for the active UL BWP
of the selected carrier:
2> start the beamFailureRecoveryTimer, if configured;
2> apply the parameters powerRampingStep,
preambleReceivedTargetPower, and preambleTransMax configured in the
beamFailureRecoveryConfig;
2> if powerRampingStepHighPriority is configured in the
beamFailureRecoveryConfig:
3> set PREAMBLE_POWER_RAMPING_STEP to the
powerRampingStepHighPriority.
2> else:
3> set PREAMBLE_POWER_RAMPING_STEP to powerRampingStep.
2> if scalingFactorBI is configured in the beamFailureRecoveryConfig:
3> set SCALING_FACTOR_BI to the scalingFactorBI.
1> else if the Random Access procedure was initiated for handover; and
1> if rach-ConfigDedicated is configured for the selected carrier:
2> if powerRampingStepHighPriority is configured in the rach-
ConfigDedicated:
3> set PREAMBLE_POWER_RAMPING_STEP to the
powerRampingStepHighPriority.
2> if scalingFactorBI is configured in the rach-ConfigDedicated:
3> set SCALING_FACTOR_BI to the scalingFactorBI.
1> perform the Random Access Resource selection procedure (see
subclause 5.1.2).

### Random Access Resource Selection

The MAC entity shall:

1> if the Random Access procedure was initiated for beam failure recovery
(as specified in subclause 5.17); and
1> if the beamFailureRecoveryTimer (in subclause 5.17) is either running or
not configured; and
1> if the contention-free Random Access Resources for beam failure
recovery request associated with any of the SSBs and/or CSI-RSs have been
explicitly provided by RRC; and
1> if at least one of the SSBs with SS-RSRP above rsrp-ThresholdSSB
amongst the SSBs in candidateBeamRSList or the CSI-RSs with CSI-RSRP
above rsrp-ThresholdCSI-RS amongst the CSI-RSs in candidateBeamRSList is
available:
2> select an SSB with SS-RSRP above rsrp-ThresholdSSB amongst the SSBs
in candidateBeamRSList or a CSI-RS with CSI-RSRP above rsrp-ThresholdCSI-
RS amongst the CSI-RSs in candidateBeamRSList;
2> if CSI-RS is selected, and there is no ra-PreambleIndex associated with
the selected CSI-RS:
3> set the PREAMBLE_INDEX to a ra-PreambleIndex corresponding to the
SSB in candidateBeamRSList which is quasi-colocated with the selected CSI-RS
as specified in 3GPP TS 38.214 [7].
2> else:
3> set the PREAMBLE_INDEX to a ra-PreambleIndex corresponding to the
selected SSB or CSI-RS from the set of Random Access Preambles for beam
failure recovery request.
1> else if the ra-PreambleIndex has been explicitly provided by PDCCH; and
1> if the ra-PreambleIndex is not 0b000000:
2> set the PREAMBLE_INDEX to the signalled ra-PreambleIndex;
2> select the SSB signalled by PDCCH.
1> else if the contention-free Random Access Resources associated with
SSBs have been explicitly provided in rach-ConfigDedicated and at least one
SSB with SS-RSRP above rsrp-ThresholdSSB amongst the associated SSBs is
available:
2> select an SSB with SS-RSRP above rsrp-ThresholdSSB amongst the
associated SSBs;
2> set the PREAMBLE_INDEX to a ra-PreambleIndex corresponding to the
selected SSB.
1> else if the contention-free Random Access Resources associated with
CSI-RSs have been explicitly provided in rach-ConfigDedicated and at least one
CSI-RS with CSI-RSRP above rsrp-ThresholdCSI-RS amongst the associated
CSI-RSs is available:
2> select a CSI-RS with CSI-RSRP above rsrp-ThresholdCSI-RS amongst
the associated CSI-RSs;
2> set the PREAMBLE_INDEX to a ra-PreambleIndex corresponding to the
selected CSI-RS.
1> else if the Random Access procedure was initiated for SI request (as
specified in 3GPP TS 38.331 [5]); and
1> if the Random Access Resources for SI request have been explicitly
provided by RRC:
2> if at least one of the SSBs with SS-RSRP above rsrp-ThresholdSSB is
available:
3> select an SSB with SS-RSRP above rsrp-ThresholdSSB
2> else:
3> select any SSB.
2> select a Random Access Preamble corresponding to the selected SSB,
from the Random Access Preamble(s) determined according to ra-
PreambleStartIndex as specified in 3GPP TS 38.331 [5];
2> set the PREAMBLE_INDEX to selected Random Access Preamble.
1> else (i.e. for the contention-based Random Access preamble selection):
2> if at least one of the SSBs with SS-RSRP above rsrp-ThresholdSSB is
available:
3> select an SSB with SS-RSRP above rsrp-ThresholdSSB.
2> else:
3> select any SSB.

The MAC entity shall, for each Random Access Preamble:

1> if PREAMBLE_TRANSMISSION_COUNTER is greater than one;
and
1> if the notification of suspending power ramping counter has not been
received from lower layers; and
1> if SSB or CSI-RS selected is not changed from the selection in the
last Random Access Preamble transmission:
2> increment PREAMBLE_POWER_RAMPING_COUNTER by 1.
1> select the value of DELTA_PREAMBLE according to subclause 7.3;
1> set PREAMBLE_RECEIVED_TARGET_POWER to
preambleReceivedTargetPower + DELTA_PREAMBLE +
(PREAMBLE_POWER_RAMPING_COUNTER − 1) ×
PREAMBLE_POWER_RAMPING_STEP;
1> except for contention-free Random Access Preamble for beam failure
recovery request, compute the RA-RNTI associated with the PRACH
occasion in which the Random Access Preamble is transmitted;
1> instruct the physical layer to transmit the Random Access Preamble
using the selected PRACH occasion, corresponding RA-RNTI (if
available), PREAMBLE_INDEX and PREAMBLE_RECEIVED_
TARGET_POWER.

The RA-RNTI associated with the PRACH occasion in which the Random Access Preamble is transmitted, is computed as:

RA-RNTI=1+s_id+14×t_id+14×80×f_id+14×80×8×ul_carrier_id

where s_id is the index of the first OFDM symbol of the PRACH occasion (0≤s_id<14), t_id is the index of the first slot of the PRACH occasion in a system frame (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier).

Once the Random Access Preamble is transmitted and regardless of the possible occurrence of a measurement gap, the MAC entity shall:

1> if the contention-free Random Access Preamble for beam failure recovery
request was transmitted by the MAC entity:
2> start the ra-ResponseWindow configured in BeamFailureRecoveryConfig
at the first PDCCH occasion as specified in 3GPP TS 38.213 [6] from the end of
the Random Access Preamble transmission;
2> monitor for a PDCCH transmission on the search space indicated by
recoverySearchSpaceId of the SpCell identified by the C-RNTI while ra-
Response Window is running.
1> else:
2> start the ra-ResponseWindow configured in RACH-ConfigCommon at the
first PDCCH occasion as specified in 3GPP TS 38.213 [6] from the end of the
Random Access Preamble transmission;
2> monitor the PDCCH of the SpCell for Random Access Response(s)
identified by the RA-RNTI while the ra-Response Window is running.
1> if notification of a reception of a PDCCH transmission on the search
space indicated by recoverySearchSpaceId is received from lower layers on the
Serving Cell where the preamble was transmitted; and
1> if PDCCH transmission is addressed to the C-RNTI; and
1> if the contention-free Random Access Preamble for beam failure recovery
request was transmitted by the MAC entity:
2> consider the Random Access procedure successfully completed.
1> else if a downlink assignment has been received on the PDCCH for the
RA-RNTI and the received TB is successfully decoded:
2> if the Random Access Response contains a MAC subPDU with Backoff
Indicator:
3> set the PREAMBLE_BACKOFF to value of the BI field of the MAC
subPDU using Table 7.2-1, multiplied with SCALING_FACTOR_BI.
2> else:
3> set the PREAMBLE_BACKOFF to 0 ms.
2> if the Random Access Response contains a MAC subPDU with Random
Access Preamble identifier corresponding to the transmitted
PREAMBLE_INDEX (see subclause 5.1.3):
3> consider this Random Access Response reception successful.
2> if the Random Access Response reception is considered successful:
3> if the Random Access Response includes a MAC subPDU with RAPID
only:
4> consider this Random Access procedure successfully completed;
4> indicate the reception of an acknowledgement for SI request to upper
layers.
3> else:
4> apply the following actions for the Serving Cell where the Random
Access Preamble was transmitted:
5> process the received Timing Advance Command (see subclause 5.2);
5> indicate the preambleReceivedTargetPower and the amount of power
ramping applied to the latest Random Access Preamble transmission to lower
layers (i.e. (PREAMBLE_POWER_RAMPING_COUNTER − 1) X
PREAMBLE_POWER_RAMPING_STEP);
5> if the Serving Cell for the Random Access procedure is SRS-only SCell:
6> ignore the received UL grant.
5> else:
6> process the received UL grant value and indicate it to the lower layers.
4> if the Random Access Preamble was not selected by the MAC entity
among the contention-based Random Access Preamble(s):
5> consider the Random Access procedure successfully completed.
4> else:
5> set the TEMPORARY_C-RNTI to the value received in the Random
Access Response;
5> if this is the first successfully received Random Access Response within
this Random Access procedure:
6> if the transmission is not being made for the CCCH logical channel:
7> indicate to the Multiplexing and assembly entity to include a C-RNTI
MAC CE in the subsequent uplink transmission.
6> obtain the MAC PDU to transmit from the Multiplexing and assembly
entity and store it in the Msg3 buffer.
NOTE:
If within a Random Access procedure, an uplink grant provided in the Random Access Response for the same group of contention-based Random Access Preambles has a different size than the first uplink grant allocated during that Random Access procedure, the WD behavior is not defined.

1> if ra-Response Window configured in BeamFailureRecoveryConfig
expires and if a PDCCH transmission on the search space indicated by
recoverySearchSpaceId.
addressed to the C-RNTI has not been received on the Serving Cell where the
preamble was transmitted; or
1> if ra-Response Window configured in RACH-ConfigCommon expires, and
if the Random Access Response containing Random Access Preamble identifiers
that matches the transmitted PREAMBLE_INDEX has not been received:
2> consider the Random Access Response reception not successful;
2> increment PREAMBLE_TRANSMISSION_COUNTER by 1;
2> if PREAMBLE_TRANSMISSION_COUNTER = preambleTransMax +
1:
3> if the Random Access Preamble is transmitted on the SpCell:
4> indicate a Random Access problem to upper layers;
4> if this Random Access procedure was triggered for SI request:
5> consider the Random Access procedure unsuccessfully completed.
3> else if the Random Access Preamble is transmitted on a SCell:
4> consider the Random Access procedure unsuccessfully completed.
2> if the Random Access procedure is not completed:
3> select a random backoff time according to a uniform distribution between
0 and the PREAMBLE_BACKOFF;
3> if the criteria (as defined in subclause 5.1.2) to select contention-free
Random Access Resources is met during the backoff time:
4> perform the Random Access Resource selection procedure (see subclause
5.1.2);
3> else:
4> perform the Random Access Resource selection procedure (see subclause
5.1.2) after the backoff time.

The MAC entity may stop ra-ResponseWindow (and hence monitoring for Random Access Response(s)) after successful reception of a Random Access Response containing Random Access Preamble identifiers that matches the transmitted PREAMBLE_INDEX. HARQ operation is not applicable to the Random Access Response reception.

The WD information procedure is used by the network to request the WD to report information.

### Initiation

The network initiates the procedure by sending the WDInformationRequest message. The network should initiate this procedure only after successful security activation.

### Reception of the WDInformationRequest Message

Upon receiving the WDInformationRequest message, the WD shall, only after successful security activation:

1> if the idleModeMeasurementReq is included in the
WDInformationRequest and the WD has stored VarMeasIdleReport that contains
measurement information concerning cells other than the PCell:
2> set the measResultIdleEUTRA in the WDInformationResponse message
to the value of measReportIdleEUTRA in the VarMeasIdleReportEUTRA, if
available;
2> set the measResultIdleNR in the WDInformationResponse message to the
value of measReportIdleNR in the VarMeasIdleReport, if available;
2> discard the VarMeasIdleReport upon successful delivery of the
WDInformationResponse message confirmed by lower layers;
1> if the logMeasReportReq is present and if the RPLMN is included in
plmn-IdentityList stored in VarLogMeasReport:
2> if VarLogMeasReport includes one or more logged measurement entries,
set the contents of the logMeasReport in the WDInformationResponse message
as follows:
3> include the absoluteTimeStamp and set it to the value of absoluteTimeInfo
in the VarLogMeasReport;
3> include the traceReference and set it to the value of traceReference in the
VarLogMeasReport;
3> include the traceRecordingSessionRef and set it to the value of
traceRecordingSessionRef in the VarLogMeasReport;
3> include the tce-Id and set it to the value of tce-Id in the
VarLogMeasReport;
3> include the logMeasInfoList and set it to include one or more entries from
VarLogMeasReport starting from the entries logged first;
3> if the VarLogMeasReport includes one or more additional logged
measurement entries that are not included in the logMeasInfoList within the
WDInformationResponse message:
4> include the logMeasAvailable;
3> if the VarLogMeasReport includes one or more additional logged
Bluetooth measurement entries that are not included in the logMeasInfoList
within the WDInformationResponse message:
4> include the logMeasAvailableBT;
3> if the VarLogMeasReport includes one or more additional logged WLAN
measurement entries that are not included in the logMeasInfoList within the
WDInformationResponse message:
4> include the logMeasAvailableWLAN;
1> if ra-ReportReq is set to true and the WD has random access related
information available in VarRA-Report and if the RPLMN is included in plmn-
IdentityList stored in VarRA-Report:
2> set the ra-Report in the WDInformationResponse message to the value of
ra-Report in VarRA-Report;
2> discard the ra-Report from VarRA-Report upon successful delivery of the
WDInformationResponse message confirmed by lower layers;
1> if rlf-ReportReq is set to true:
2> if the WD has radio link failure information or handover failure
information available in VarRLF-Report and if the RPLMN is included in plmn-
IdentityList stored in VarRLF-Report:
3> set timeSinceFailure in VarRLF-Report to the time that elapsed since the
last radio link or handover failure in NR;
3> set the rlf-Report in the WDInformationResponse message to the value of
rlf-Report in VarRLF-Report;
3> discard the rlf-Report from VarRLF-Report upon successful delivery of
the WDInformationResponse message confirmed by lower layers;
2> else if the WD has radio link failure information or handover failure
information available in VarRLF-Report of 3GPP TS 36.331 [10] and if the
RPLMN is included in plmn-IdentityList stored in VarRLF-Report of 3GPP TS
36.331 [10]:
3> set timeSinceFailure in VarRLF-Report of 3GPP TS 36.331 [10] to the
time that elapsed since the last radio link or handover failure in EUTRA;
3> set the measResult-RLF-Report-EUTRA in the rlf-Report in the
WDInformationResponse message to the value of rlf-Report in VarRLF-Report
of 3GPP TS 36.331 [10];
3> discard the rlf-Report from VarRLF-Report of 3GPP TS 36.331 [10] upon
successful delivery of the WDInformationResponse message confirmed by lower
layers;
1> if connEstFailReportReq is set to true and the WD has connection
establishment failure or connection resume failure information in
VarConnEstFailReport and if the RPLMN is equal to plmn-Identity stored in
VarConnEstFailReport:
2> set timeSinceFailure in VarConnEstFailReport to the time that elapsed
since the last connection establishment failure or connection resume failure in
NR;
2> set the connEstFailReport in the WDInformationResponse message to the
value of connEstFailReport in VarConnEstFailReport;
2> discard the connEstFailReport from VarConnEstFailReport upon
successful delivery of the WDInformationResponse message confirmed by lower
layers;
1> if the mobilityHistoryReportReq is set to true:
2> include the mobilityHistoryReport and set it to include entries from
VarMobilityHistoryReport;
2> include in the mobilityHistoryReport an entry for the current cell, possibly
after removing the oldest entry if required, and set its fields as follows:
3> set visitedCellId to the global cell identity of the current cell:
3> set field timeSpent to the time spent in the current cell;
1> if the logMeasReport is included in the WDInformationResponse:
2> submit the WDInformationResponse message to lower layers for
transmission via SRB2;
2> discard the logged measurement entries included in the logMeasInfoList
from VarLogMeasReport upon successful delivery of the
WDInformationResponse message confirmed by lower layers;
1> else:
2> submit the WDInformationResponse message to lower layers for
transmission via SRB1.
Upon successfully performing 4 step random access procedure, the WD shall:
1> if the number of RA-Report stored in the RA-ReportList is less than 8 and
if the number of PLMN entries in plmn-IdentityList stored in VarRA-Report is
less than maxPLMN, then append the following contents associated to the
successfully completed random-access procedure as a new entry in the VarRA-
Report:
2> if the list of EPLMNs has been stored by the WD:
3> if the RPLMN is included in plmn-IdentityList stored in VarRA-Report:
4> set the plmn-IdentityList to include the list of EPLMNs stored by the WD
(i.e. includes the RPLMN) without exceeding the limit of maxPLMN;
3> else:
4> clear the information included in VarRA-Report;
4> set the plmn-IdentityList to the list of EPLMNs stored by the WD (i.e.
includes the RPLMN);
2> else:
3> set the plmn-Identity, in plmn-IdentityList, to the PLMN selected by upper
layers from the PLMN(s) included in the plmn-IdentityList in SIB1;
2> set the cellId to the global cell identity and the tracking area code of the
cell in which the random-access procedure was performed;
2> set the raPurpose to include the purpose of triggering the random-access
procedure;
2> set the ra-InformationCommon-r16 as specified in subclause 5.7.10.5.

The WD may discard the random access report information, i.e.,, release the WD variable VarRA-Report, 48 hours after the last successful random access procedure related information is added to the VarRA-Report.

### RA Information Determination for RA Report and Radio Link Failure (RLF) Report

The WD shall set the content in ra-InformationCommon-r16 as follows:

1> set the absoluteFrequencyPointA to indicate the absolute frequency of the
reference resource block associated to the random-access resources used in the
random-access procedure;
1> set the locationAndBandwidth and subcarrierSpacing associated to the
UL BWP of the random-access resources used in the random-access procedure;
1> set the msg1-FrequencyStart, msg1-FDM and msg1-SubcarrierSpacing
associated to the contention based random-access resources used in the random-
access procedure;
1> set the msg1-FrequencyStartCFRA, msg1-FDMCFRA and msg1-
SubcarrierSpacingCFRA associated to the contention free random-access
resources used in the random-access procedure;
1> set the parameters associated to individual random-access attempt in the
chronological order of attempts in the perRAInfoList as follows:
2> if the random-access resource used is associated to a SS/PBCH block, set
the associated random-access parameters for the successive random-access
attempts associated to the same SS/PBCH block for one or more random-access
attempts as follows:
3> set the ssb-Index to include the SS/PBCH block index associated to the
used random-access resource;
3> set the numberOfPreamblesSentOnSSB to indicate the number of
successive random-access attempts associated to the SS/PBCH block;
3> for each random-access attempt performed on the random-access
resource, include the following parameters in the chronological order of the
random-access attempt:
4> if the random-access attempt is performed on the contention based
random-access resource and if raPurpose is not equal to 'requestForOtherSI',
include contentionDetected as follows:
5> if contention resolution was not successful as specified in 3GPP TS
38.321 [6] for the transmitted preamble:
6> set the contentionDetected to true;
5> else:
6> set the contentionDetected to false;
4> if the random-access attempt is performed on the contention based
random-access resource; or
4> if the random-access attempt is performed on the contention free random-
access resource and if the random-access procedure was initiated due to the
PDCCH ordering:
5> if the SS/PBCH block RSRP of the SS/PBCH block corresponding to the
random-access resource used in the random-access attempt is above rsrp-
ThresholdSSB:
6> set the dlRSRPAboveThreshold to true;
5> else:
6> set the dlRSRPAboveThreshold to false;
2> else if the random-access resource used is associated to a CSI-RS, set the
associated random-access parameters for the successive random-access attempts
associated to the same CSI-RS for one or more random-access attempts as
follows:
3> set the csi-RS-Index to include the CSI-RS index associated to the used
random-access resource;
3> set the numberOfPreamblesSentOnCSI-RS to indicate the number of
successive random-access attempts associated to the CSI-RS.
NOTE 1:
The WD does not log the RA information in the RA report if the triggering event of the random access is consistent uplink (UL) look before talk (LBT) on SpCell as specified in 3GPP TS 38.321 [6].

The WDInformationResponse message is used by the WD to transfer information requested by the network.

Signaling radio bearer: SRB1 or SRB2 (when logged measurement information is included)

```
RLC-SAP: AM
Logical channel: DCCH
Direction: WD to network
-- ASN1START
-- TAG-UEINFORMATIONRESPONSE-START
UEInformationResponse-r16::= SEQUENCE {
  rrc-TransactionIdentifier RRC-TransactionIdentifier,
  criticalExtensions CHOICE {
    ueInformationResponse-r16 WDInformationResponse-r16-IEs,
    criticalExtensionsFuture SEQUENCE { }
  }
}
UEInformationResponse-r16-IEs::= SEQUENCE {
  measResultIdleEUTRA-r16 MeasResultIdleEUTRA-r16
OPTIONAL,
  measResultIdleNR-r16 MeasResultIdleNR-r16
OPTIONAL,
  logMeasReport-r16 LogMeasReport-r16 OPTIONAL,
  connEstFailReport-r16 ConnEstFailReport-r16 OPTIONAL,
  ra-ReportList-r16 RA-ReportList-r16 OPTIONAL,
  rlf-Report-r16 RLF-Report-r16 OPTIONAL,
  mobility HistoryReport-r16 MobilityHistoryReport-r16
OPTIONAL,
  lateNonCriticalExtension OCTET STRING OPTIONAL,
  nonCriticalExtension SEQUENCE { } OPTIONAL
}
LogMeasReport-r16::= SEQUENCE {
  absoluteTimeStamp-r16 AbsoluteTimeInfo-r16,
  traceReference-r16 TraceReference-r16,
  traceRecordingSessionRef-r16 OCTET STRING (SIZE (2)),
  tce-Id-r16 OCTET STRING (SIZE (1)),
  logMeasInfoList-r16 LogMeasInfoList-r16,
  logMeasAvailable-r16 ENUMERATED {true}
OPTIONAL,
  logMeasAvailableBT-r16 ENUMERATED {true}
OPTIONAL,
  logMeasAvailableWLAN-r16 ENUMERATED {true}
OPTIONAL,
  ...
}
LogMeasInfoList-r16::= SEQUENCE (SIZE (1..maxLogMeasReport-
r16)) OF LogMeasInfo-r16
LogMeasInfo-r16::= SEQUENCE {
  locationInfo-r16 LocationInfo-r16 OPTIONAL,
  relativeTimeStamp-r16 INTEGER (0..7200),
  servCellIdentity-r16 CGI-Info-Logging-r16 OPTIONAL,
  measResultServingCell-r16 MeasResultServingCell-r16
OPTIONAL,
  measResultNeighCells-r16 SEQUENCE {
    measResultNeighCellListNR MeasResultListLogging2NR-r16
OPTIONAL,
    measResultNeighCellListEUTRA MeasResultList2EUTRA-r16
OPTIONAL
  },
  anyCellSelectionDetected-r16 ENUMERATED { true}
OPTIONAL
}
ConnEstFailReport-r16::= SEQUENCE {
  measResultFailedCell-r16 MeasResultFailedCell-r16,
  locationInfo-r16 LocationInfo-r16 OPTIONAL,
  measResultNeighCells-r16 SEQUENCE {
    measResultNeighCellListNR MeasResultList2NR-r16
OPTIONAL,
    measResultNeighCellListEUTRA MeasResultList2EUTRA-r16
OPTIONAL
  },
  numberOfConnFail-r16 INTEGER (1..8),
  perRAInfoList-r16 PerRAInfoList-r16,
  timeSinceFailure-r16 TimeSinceFailure-r16,
  ...
}
MeasResultServingCell-r16::= SEQUENCE {
  resultsSSB-Cell MeasQuantityResults,
  resultsSSB SEQUENCE{
    best-ssb-Index SSB-Index,
    best-ssb-Results MeasQuantityResults,
    numberOfGoodSSB INTEGER (1..maxNrofSSBs-r16)
  } OPTIONAL
}
MeasResultFailedCell-r16::= SEQUENCE {
  cgi-Info CGI-Info-Logging-r16,
  measResult-r16 SEQUENCE {
    cellResults-r16 SEQUENCE{
      resultsSSB-Cell-r16 MeasQuantityResults
    },
    rsIndexResults-r16 SEQUENCE{
      resultsSSB-Indices-r16 ResultsPerSSB-IndexList
    }
  }
}
RA-ReportList-r16::= SEQUENCE (SIZE (1..maxRAReport-r16)) OF RA-
Report-r16
RA-Report-r16::= SEQUENCE {
  cellId-r16 CGI-Info-Logging-r16,
  ra-InformationCommon-r16 RA-InformationCommon-r16,
  raPurpose-r16 ENUMERATED { accessRelated,
beamFailureRecovery, reconfiguration WithSync, ulUnSynchronized,
                            schedulingRequestFailure,
  noPUCCHResourceAvailable, requestForOtherSI,
                            spare9, spare8, spare7, spare6, spare5, spare4,
spare3, spare2, spare1}
}
  RA-InformationCommon-r16::= SEQUENCE {
  absoluteFrequencyPointA-r16 ARFCN-ValueNR,
  locationAndBandwidth-r16 INTEGER (0..37949),
  subcarrierSpacing-r16 SubcarrierSpacing,
  msg1-FrequencyStart-r16 INTEGER
(0..maxNrofPhysicalResourceBlocks−1) OPTIONAL,
  msg1-FrequencyStartCFRA-r16 INTEGER
(0..maxNrofPhysicalResourceBlocks−1) OPTIONAL,
  msg1-SubcarrierSpacing-r16 SubcarrierSpacing
OPTIONAL,
  msg1-SubcarrierSpacingCFRA-r16 SubcarrierSpacing
OPTIONAL,
  msg1-FDM-r16 ENUMERATED {one, two, four, eight}
OPTIONAL,
  msg1-FDMCFRA-r16 ENUMERATED {one, two, four, eight}
OPTIONAL,
  perRAInfoList-r16 PerRAInfoList-r16
}
PerRAInfoList-r16::= SEQUENCE (SIZE (1..200)) OF PerRAInfo-r16
PerRAInfo-r16::= CHOICE {
  perRASSBInfoList-r16 PerRASSBInfo-r16,
  perRACSI-RSInfoList-r16 PerRACSI-RSInfo-r16
}
PerRASSBInfo-r16::= SEQUENCE {
  ssb-Index-r16 SSB-Index,
  numberOfPreamblesSentOnSSB-r16 INTEGER (1..200),
  perRAAttemptInfoList-r16 PerRAAttemptInfoList-r16
}
PerRACSI-RSInfo-r16::= SEQUENCE {
  csi-RS-Index-r16 CSI-RS-Index,
  numberOfPreamblesSentOnCSI-RS-r16 INTEGER (1..200)
}
PerRAAttemptInfoList-r16::= SEQUENCE (SIZE (1..200)) OF
PerRAAttemptInfo-r16
PerRAAttemptInfo-r16::= SEQUENCE {
  contentionDetected-r16 BOOLEAN OPTIONAL,
  dIRSRPAboveThreshold-r16 BOOLEAN OPTIONAL,
  ...
}
RLF-Report-r16::= CHOICE {
  nr-RLF-Report-r16 SEQUENCE {
    measResultLastServCell-r16 MeasResultRLFNR-r16,
    measResultNeighCells-r16 SEQUENCE {
      measResultListNR-r16 MeasResultList2NR-r16
OPTIONAL,
      measResultListEUTRA-r16 MeasResultList2EUTRA-r16
OPTIONAL
    } OPTIONAL,
    c-RNTI-r16 RNTI-Value,
    previousPCellId-r16 CHOICE {
      nrPreviousCell-r16 CGI-Info-Logging-r16,
      eutraPreviousCell-r16 CGI-InfoEUTRALogging
    } OPTIONAL,
    failedPCellId-r16 CHOICE {
      nrFailedPCellId-r16 CHOICE {
        cellGlobalId-r16 CGI-Info-Logging-r16,
        pci-arfcn-r16 SEQUENCE {
          physCellId-r16 PhysCellId,
          carrierFreq-r16 ARFCN-ValueNR
        }
      },
      eutraFailedPCellId-r16 CHOICE {
        cellGlobalId-r16 CGI-InfoEUTRALogging,
        pci-arfcn-r16 SEQUENCE {
          physCellId-r16 EUTRA-PhysCellId,
          carrierFreq-r16 ARFCN-ValueEUTRA
        }
      }
    },
    reconnectCellId-r16 CHOICE {
        nrReconnectCellId-r16 CGI-Info-Logging-r16,
        eutraReconnectCellId-r16 CGI-InfoEUTRALogging
    } OPTIONAL,
    timeUntilReconnection-16 TimeUntilReconnection-16
OPTIONAL,
    reestablishmentCellId-r16 CGI-Info-Logging-r16
OPTIONAL,
    timeConnFailure-r16 INTEGER (0..1023)
OPTIONAL,
    timeSinceFailure-r16 TimeSinceFailure-r16,
    connectionFailureType-r16 ENUMERATED {rlf, hof},
    rlf-Cause-r16 ENUMERATED {t310-Expiry,
randomAccessProblem, rlc-MaxNumRetx,
                                    beamFailureRecoveryFailure, IbtFailure-r16,
                                    bh-rlfRecoveryFailure, spare2, spare1 },
    locationInfo-r16 LocationInfo-r16
OPTIONAL,
    noSuitableCellFound-r16 ENUMERATED { true}
OPTIONAL,
    ra-InformationCommon-r16 RA-InformationCommon-r16
OPTIONAL
  },
  eutra-RLF-Report-r16 SEQUENCE {
    failedPCellId-EUTRA CGI-InfoEUTRALogging,
    measResult-RLF-Report-EUTRA-r16 OCTET STRING
  }
}
MeasResultList2NR-r16::= SEQUENCE(SIZE (1..maxFreq)) OF
MeasResult2NR-r16
MeasResultList2EUTRA-r16::= SEQUENCE(SIZE (1..maxFreq)) OF
MeasResult2EUTRA-r16
MeasResult2NR-r16::= SEQUENCE {
  ssbFrequency-r16 ARFCN-ValueNR
OPTIONAL,
  refFreqCSI-RS-r16 ARFCN-ValueNR
OPTIONAL,
  measResultList-r16 MeasResultListNR
}
MeasResultListLogging2NR-r16::= SEQUENCE(SIZE (1..maxFreq)) OF
MeasResultListLoggingNR-r16
MeasResultLogging2NR-r16::= SEQUENCE {
  carrierFreq-r16 ARFCN-ValueNR,
  measResultListLoggingNR-r16 MeasResultListLoggingNR-r16
}
MeasResultListLoggingNR-r16::= SEQUENCE (SIZE (1..maxCellReport))
OF MeasResultLoggingNR-r16
MeasResultLoggingNR-r16::= SEQUENCE {
  physCellId-r16 PhysCellId,
  resultsSSB-Cell-r16 MeasQuantityResults,
  numberOfGoodSSB-r16 INTEGER (1..maxNrofSSBs-r16)
OPTIONAL
}
MeasResult2EUTRA-r16::= SEQUENCE {
  carrierFreq-r16 ARFCN-ValueEUTRA,
  measResultList-r16 MeasResultListEUTRA
}
MeasResultRLFNR-r16::= SEQUENCE {
  measResult-r16 SEQUENCE {
    cellResults-r16 SEQUENCE{
      resultsSSB-Cell-r16 MeasQuantityResults
OPTIONAL,
      resultsCSI-RS-Cell-r16 MeasQuantityResults
OPTIONAL,
    },
    rsIndexResults-r16 SEQUENCE{
      resultsSSB-Indices-r16 ResultsPerSSB-IndexList
OPTIONAL,
      ssbRLMConfigBitmap-r16 BIT STRING (SIZE (64))
OPTIONAL,
      resultsCSI-RS-Indices-r16 ResultsPerCSI-RS-IndexList
OPTIONAL
      csi-rsRLMConfigBitmap-r16 BIT STRING (SIZE (96))
OPTIONAL
    } OPTIONAL
  }
}
TimeSinceFailure-r16::= INTEGER (0..172800)
Mobility History Report-r16::= VisitedCellInfoList-r16
TimeUntilReconnection-16::= INTEGER (0..172800)
```

A purpose of the RA-Report transmitted from the WD to the network in the WDInformationResponse message is to enable the network to optimize the related configuration parameters. However, not all relevant information is available in the report, e.g., for configuring preamble groups.

### SUMMARY

Some embodiments advantageously provide methods, network nodes and wireless devices for inclusion of preamble group information in a random access (RA) report.

Some embodiments described herein include configuring a WD to include information related to the preamble group selection when it transmits an RA-Report to the network in a WDInformationResponse message. This information may include:
Selected preamble group (group A or B);
Reason for the selection of the selected preamble group;
The amount of data the WD had available for transmission in Msg3 or MsgA PUSCH that did not fit into the allocated uplink transmission resources for Msg3 or MsgA PUSCH.

Some embodiments enable the network to perform and make well-founded decisions as to how to optimize the preamble group related parameters in a cell.

According to one aspect, a WD is configured to wirelessly communicate with a network node by engaging in a random access procedure. The WD includes processing circuitry configured to: determine that a first condition is satisfied when an amount of data for transmission in a message to be sent in reply to a random access response, RAR, signal from the network node exceeds a first threshold; determine that a second condition is satisfied when a pathloss indication falls below a second threshold. When both the first and second conditions are satisfied, the processing circuitry is configured to select a first preamble group from which a preamble is selected to be included in a random access message. Otherwise, the processing circuitry is configured to select a second preamble group from which a preamble is selected to be included in the random access message. The WD also includes a radio interface in communication with the processing circuitry and configured to transmit a report to the network node, the report comprising at least one of: which of the first and second preamble group is selected; which of the first and second conditions are determined to occur; and when the first condition is determined to occur, then a surplus amount to which the data for transmission in the message to be sent in the reply to the RAR signal exceeds the first threshold.

According to this aspect, in some embodiments, the message is a Msg3 of a four-step random access procedure. In some embodiments, the message is a MsgA of a two-step random access procedure. In some embodiments, the surplus amount is reported to the network node only when the first preamble group is selected. In some embodiments, only the surplus amount is reported to the network node when only the first preamble group is selected.

According to another aspect, a method for a wireless device, WD, to wirelessly communicate with a network node by engaging in a random access procedure is provided. The method includes: determining that a first condition is satisfied when an amount of data for transmission in a message to be sent in reply to a random access response, RAR, signal from the network node exceeds a first threshold; determining a that a second condition is satisfied when a pathloss indication falls below a second threshold; and when both the first and second conditions are satisfied, selecting a first preamble group from which a preamble is selected to be included in a random access message; otherwise selecting a second preamble group from which a preamble is selected to be included in the random access message. The method also includes transmitting a report to the network node, the report comprising at least one of: which of the first and second preamble group is selected; which of the first and second conditions are determined to occur; and when the first condition is satisfied, then, a surplus amount to which the data for transmission in the message to be sent in the reply to the RAR signal exceeds the first threshold.

According to this aspect, in some embodiments, the message is a Msg3 of a four-step random access procedure. In some embodiments, the message is a MsgA of a two-step random access procedure. In some embodiments, the method also includes reporting the surplus amount to the network node only when the first preamble group is selected. In some embodiments, the method also includes reporting only the surplus amount to the network node when only the first preamble group is selected.

According to another aspect, a network node is configured to wirelessly communicate with a wireless device, WD, by engaging in a random access procedure. The network node includes a radio interface configured to receive a report from the WD, the report comprising at least one of: a selection of one of a first preamble group and a second preamble group by the WD; an indication that at least one of a first condition and a second condition is satisfied, the first condition being satisfied when a first amount of data for transmission by the WD in reply to a random access response, RAR, signal from the network node exceeds a first threshold, the second condition being satisfied when a pathloss indication falls below a second threshold; and a surplus amount by which the first amount exceeds the first threshold. The network node also includes processing circuitry in communication with the radio interface and configured to configure at least one of a first preamble group and a second preamble group based at least in part on the report received from the WD, the radio interface being configured to transmit an indication of which of the first and second preamble groups are configured.

According to this aspect, in some embodiments, when the report does not indicate that the second condition is satisfied and indicates that the first condition is satisfied, then the processing circuitry is further configured to increase a preamble target power parameter. In some embodiments, when the report does not indicate that the first condition is satisfied and indicates that the second condition is satisfied, then the processing circuitry is configured to reduce a number of preambles in the first preamble group. In some embodiments, both the first preamble group and the second preamble group are configured when the report does not indicate that the first condition is satisfied and does not indicate that the second condition is satisfied. In some embodiments, when the report indicates that the first preamble is selected, the processing circuitry is configured to configure only the first preamble group based at least in part on the surplus amount.

According to yet another aspect, in some embodiments, a method in a network node for wirelessly communicating with a wireless device, WD, by engaging in a random access procedure is provided. The network node includes receiving a report from the WD, the report comprising at least one of: a selection of one of a first preamble group and a second preamble group by the WD; an indication that at least one of a first condition and a second condition is satisfied, the first condition being satisfied when a first amount of data for transmission by the WD in reply to a random access response, RAR, signal from the network node exceeds a first threshold, the second condition being satisfied when a pathloss indication falls below a second threshold; and a surplus amount by which the first amount exceeds the first threshold. The method also includes configuring at least one of a first preamble group and a second preamble group based at least in part on the report received from the WD, the radio interface being configured to transmit an indication of which of the first and second preamble groups are configured.

According to this aspect, in some embodiments, the method also includes, when the report does not indicate that the second condition is satisfied and indicates that the first condition is satisfied, increasing a preamble target power parameter. In some embodiments, the method also includes, when the report does not indicate that the first condition is satisfied and indicates that the second condition is satisfied, reducing a number of preambles in the first preamble group. In some embodiments, both the first preamble group and the second preamble group are configured when the report does not indicate that the first condition is satisfied and does not indicate that the second condition is satisfied. In some embodiments, the method further includes, when the report indicates that the first preamble is selected, configuring only the first preamble group based at least in part on the surplus amount.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a 4 step RA procedure;

FIG. 2 shows a PRACH occasion configuration;

FIG. 3 shows a PRACH occasion configuration;

FIG. 4 shows a PRACH occasion configuration;

FIG. 5 shows mapping between SSB and RA preambles;

FIG. 6 shows associated preambles;

FIG. 7 shows a two-step initial access procedure;

FIG. 8 shows associated preambles;

FIG. 9 shows CFRA with 4 step RA and two step RA;;

FIG. 10 shows beams identified by SSB;

FIG. 11 shows a PRACH occasion configuration;

FIG. 12 shows another PRACH occasion configuration;

FIG. 13 shows transmission of different beams;

FIG. 14 is a schematic diagram of an exemplary network architecture illustrating a communication system connected via an intermediate network to a host computer according to the principles in the present disclosure;

FIG. 15 is a block diagram of a host computer communicating via a network node with a wireless device over an at least partially wireless connection according to some embodiments of the present disclosure;

FIG. 16 is a flowchart illustrating exemplary methods implemented in a communication system including a host computer, a network node and a wireless device for executing a client application at a wireless device according to some embodiments of the present disclosure;

FIG. 17 is a flowchart illustrating exemplary methods implemented in a communication system including a host computer, a network node and a wireless device for receiving user data at a wireless device according to some embodiments of the present disclosure;

FIG. 18 is a flowchart illustrating exemplary methods implemented in a communication system including a host computer, a network node and a wireless device for receiving user data from the wireless device at a host computer according to some embodiments of the present disclosure;

FIG. 19 is a flowchart illustrating exemplary methods implemented in a communication system including a host computer, a network node and a wireless device for receiving user data at a host computer according to some embodiments of the present disclosure;

FIG. 20 is a flowchart of an exemplary process in a network node for inclusion of preamble group information in a random access (RA) report;

FIG. 21 is a flowchart of an exemplary process in a wireless device for inclusion of preamble group information in a random access (RA) report;

FIG. 22 is a flowchart of another example process in a wireless device configured to engage in a random access procedure according to principles set forth herein; and

FIG. 23 is a flowchart of another example in a network node configured to engage in a random access procedure according to principles set forth herein.

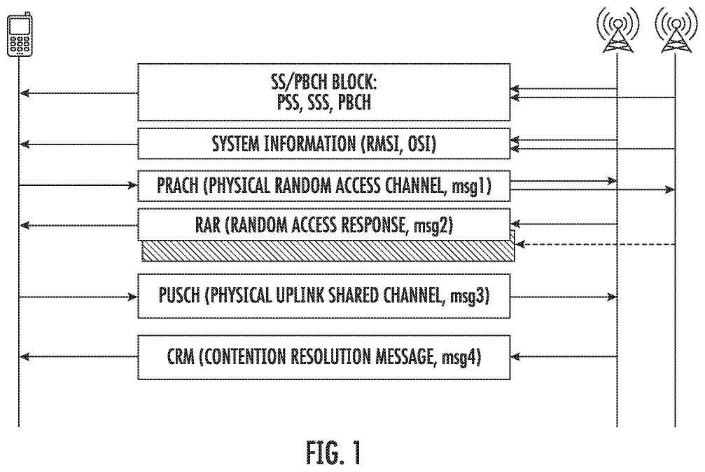

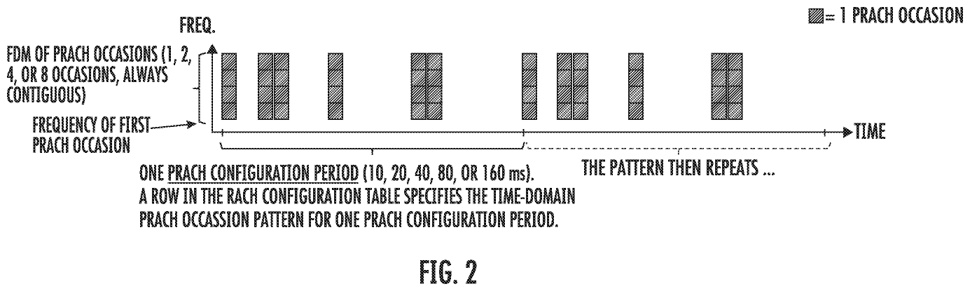

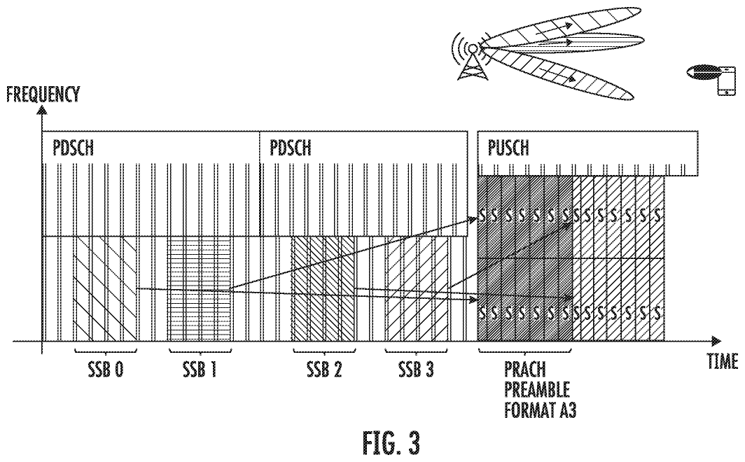

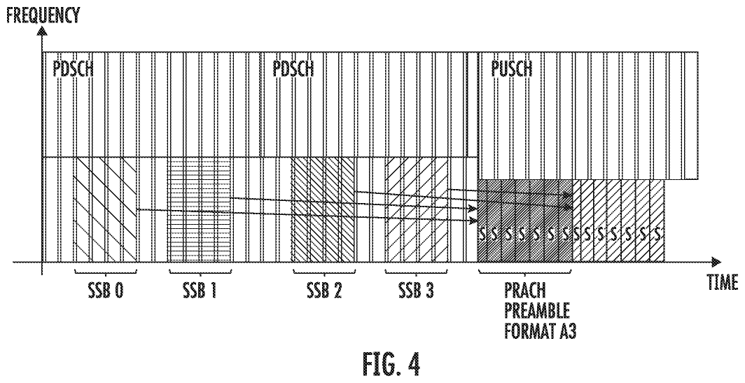

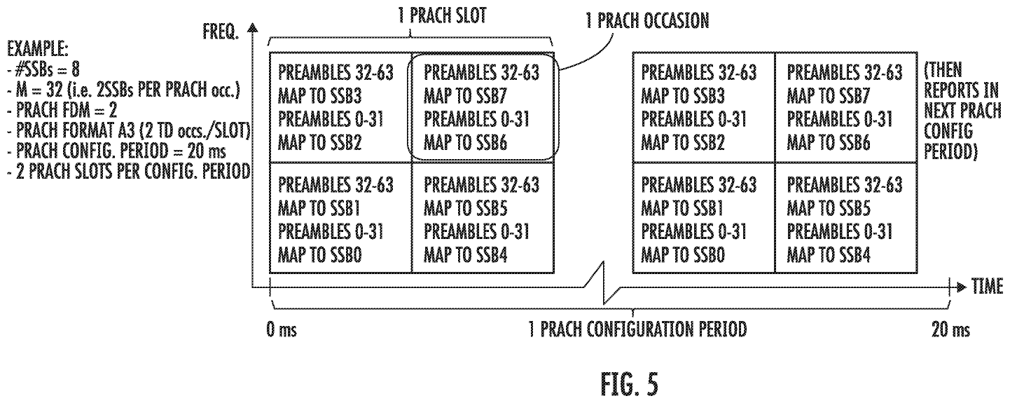

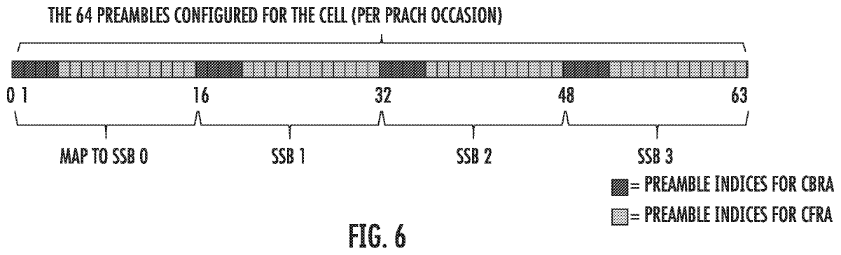

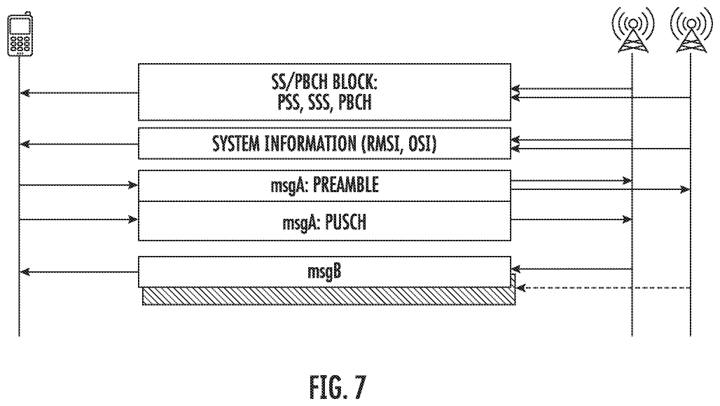

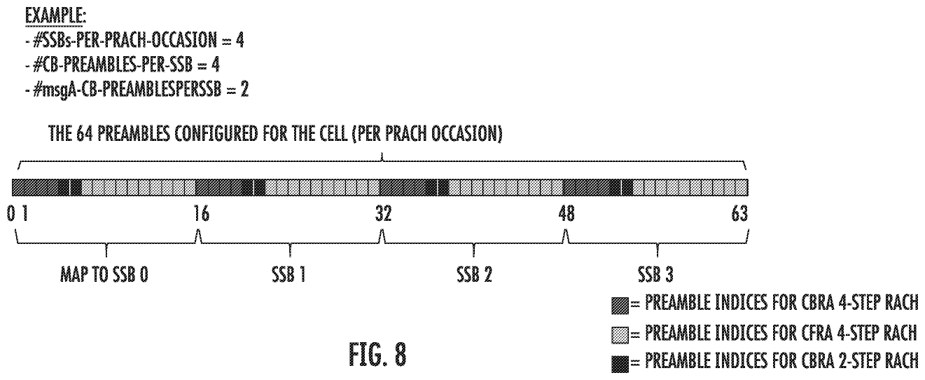

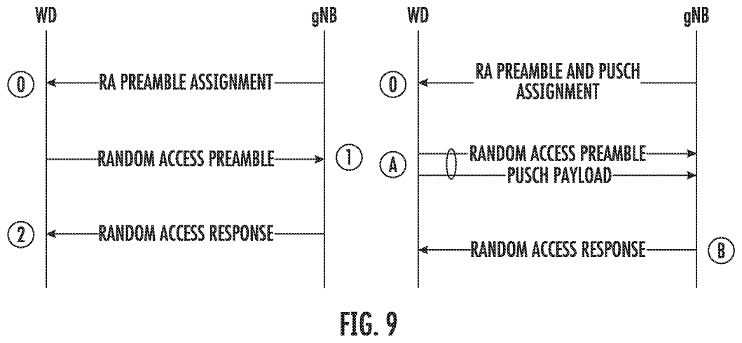

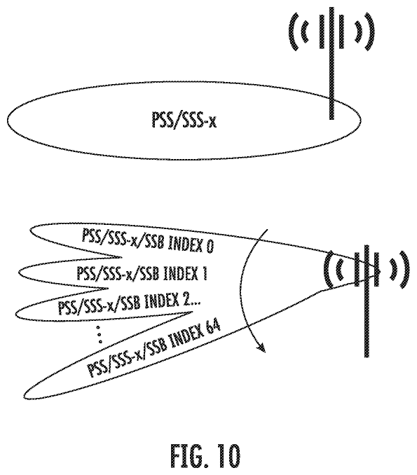

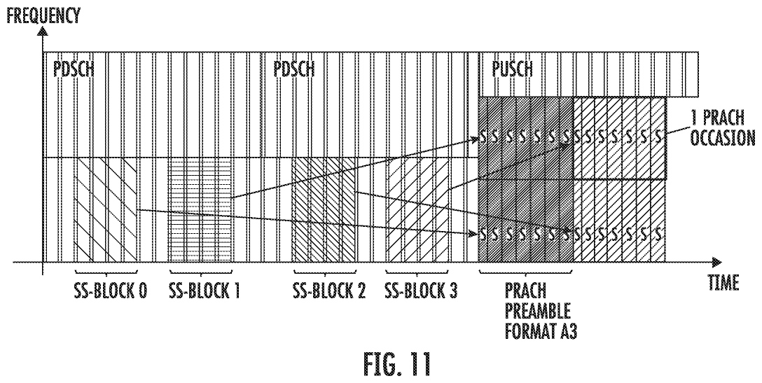

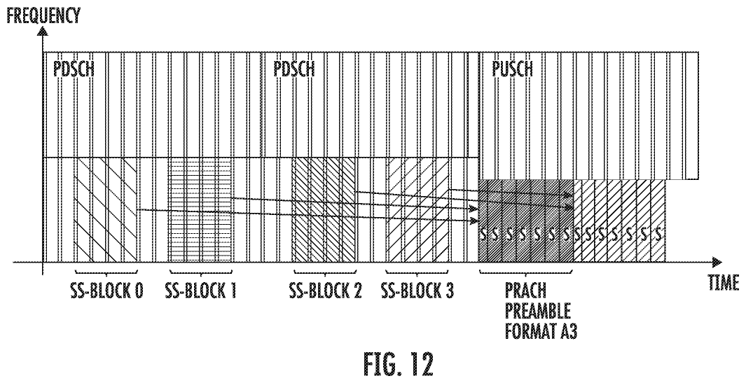

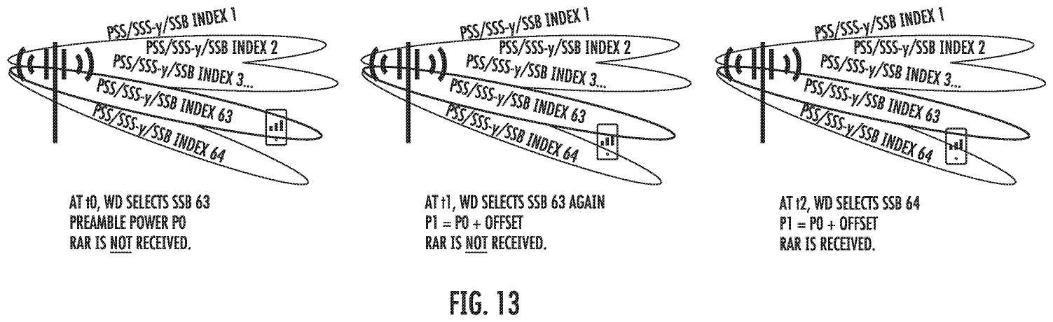

### DETAILED DESCRIPTION

Before describing in detail exemplary embodiments, it is noted that the embodiments reside primarily in combinations of apparatus components and processing steps related to inclusion of preamble group information in a random access (RA) report. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped

(LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide inclusion of preamble group information in a random access (RA) report.

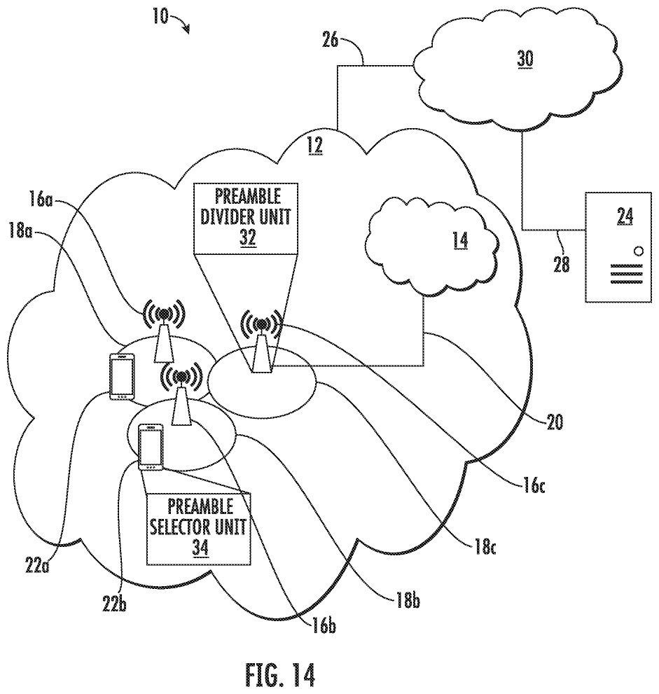

Returning now to the drawing figures, in which like elements are referred to by like reference numerals, there is shown in FIG. 14 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NB s, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 14 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a preamble group configuration unit 32 which is configured to divide preambles available for contention based random access (RA) in a cell into two preamble groups. The preamble group configuration unit 32 may be configured to configure at least one of a first preamble group and a second preamble group based at least in part on the report received from the WD. A wireless device 22 is configured to include a preamble selector unit 34 which is configured to select a preamble group based at least in part on the preamble group information. The preamble selector unit 34 may be configured to select a preamble group based at least in part on whether first and second conditions related to an amount of data in a RAR reply message and a pathloss indication.

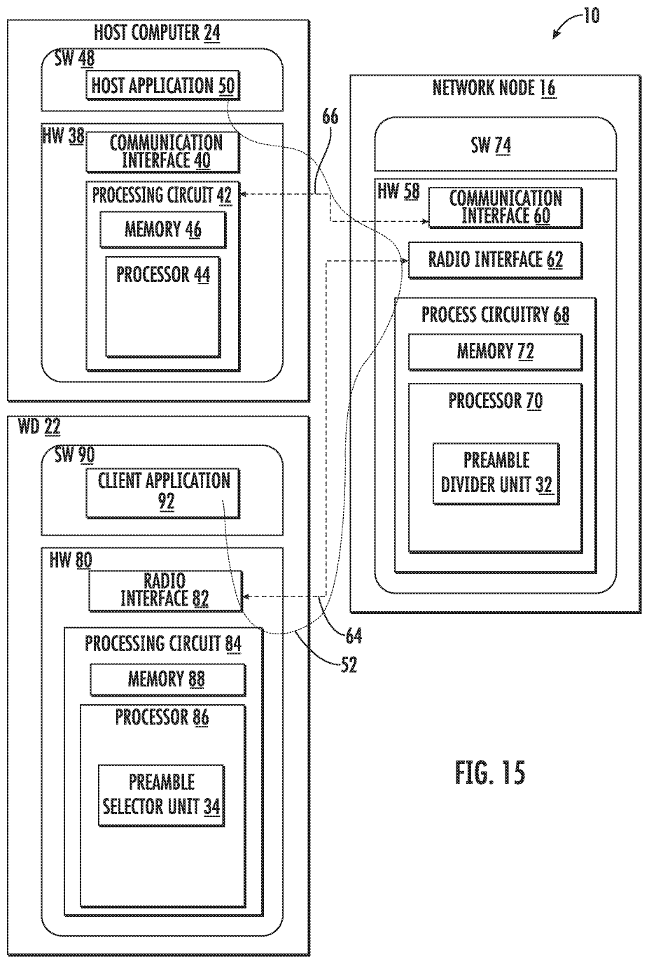

Example implementations, in accordance with an embodiment, of the WD 22, network node 16 and host computer 24 discussed in the preceding paragraphs will now be described with reference to FIG. 15. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a preamble group configuration unit 32 which is configured to divide preambles available for contention based random access (RA) in a cell into two preamble groups. The preamble group configuration unit 32 may be configured to configure at least one of a first preamble group and a second preamble group based at least in part on the report received from the WD.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a preamble selector unit 34 which is configured to select a preamble group based at least in part on the preamble group information. The preamble selector unit 34 may be configured to select a preamble group based at least in part on whether first and second conditions related to an amount of data in a RAR reply message and a pathloss indication.

In some embodiments, the inner workings of the network node 16, WD 22, and host computer 24 may be as shown in FIG. 15 and independently, the surrounding network topology may be that of FIG. 14.

In FIG. 15, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 14 and 15 show various “units” such as preamble group configuration unit 32, and preamble selector unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

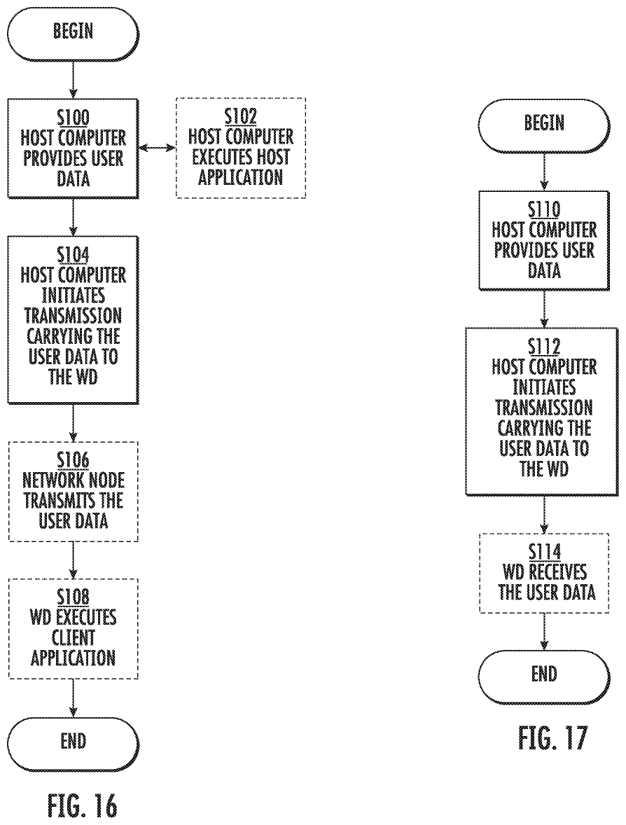

FIG. 16 is a flowchart illustrating an exemplary method implemented in a communication system, such as, for example, the communication system of FIGS. 14 and 15, in accordance with one embodiment. The communication system may include a host computer 24, a network node 16 and a WD 22, which may be those described with reference to FIG. 15. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 17 is a flowchart illustrating an exemplary method implemented in a communication system, such as, for example, the communication system of FIG. 14, in accordance with one embodiment. The communication system may include a host computer 24, a network node 16 and a WD 22, which may be those described with reference to FIGS. 14 and 15. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

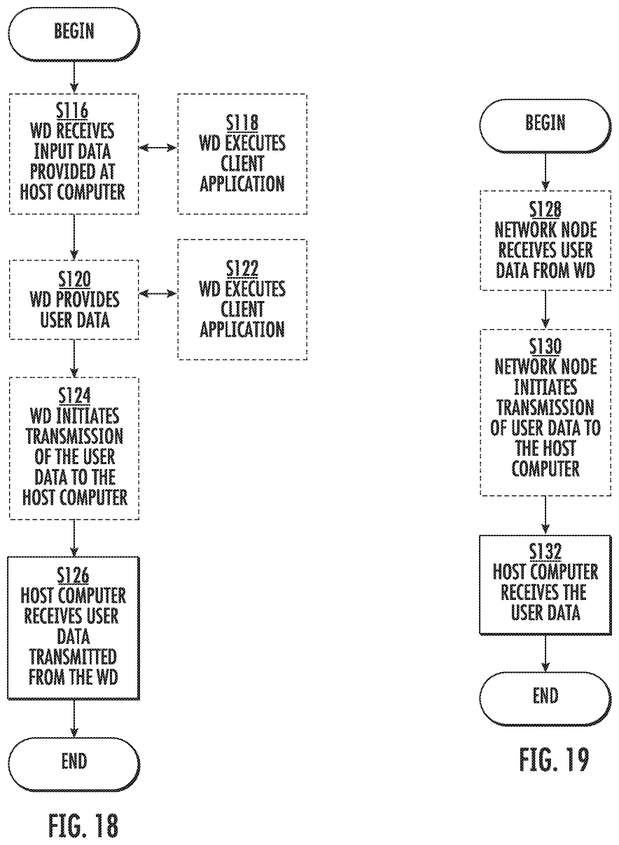

FIG. 18 is a flowchart illustrating an exemplary method implemented in a communication system, such as, for example, the communication system of FIG. 14, in accordance with one embodiment. The communication system may include a host computer 24, a network node 16 and a WD 22, which may be those described with reference to FIGS. 14 and 15. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 19 is a flowchart illustrating an exemplary method implemented in a communication system, such as, for example, the communication system of FIG. 14, in accordance with one embodiment. The communication system may include a host computer 24, a network node 16 and a WD 22, which may be those described with reference to FIGS. 14 and 15. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

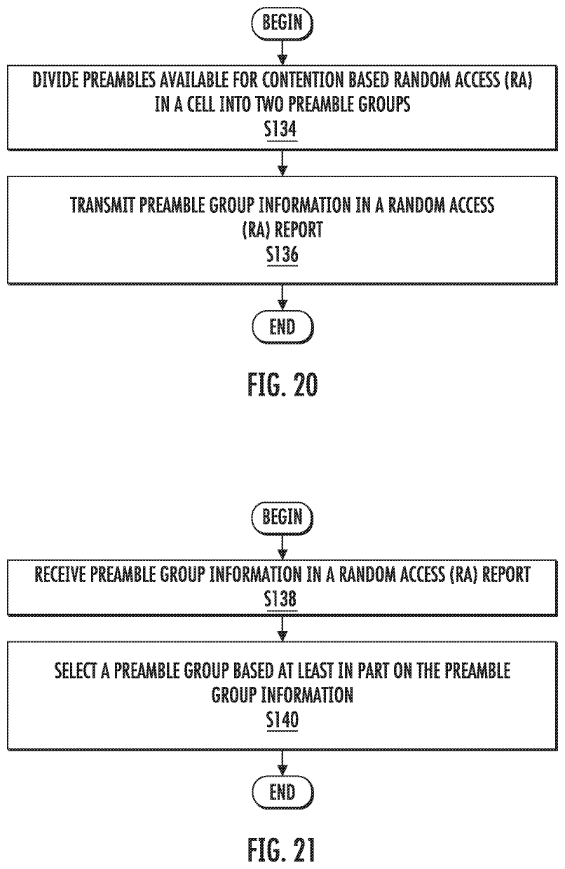

FIG. 20 is a flowchart of an exemplary process in a network node 16 for inclusion of preamble group information in a random access (RA) report. One or more blocks described herein may be performed by one or more elements of network node 16 such as by one or more of processing circuitry 68 (including the preamble group configuration unit 32), processor 70, radio interface 62 and/or communication interface Network node 16 such as via processing circuitry 68 and/or processor 70 and/or radio interface 62 and/or communication interface 60 is configured to divide preambles available for contention based random access (RA) in a cell into two preamble groups (Block S134). The process also includes transmitting preamble group information in a random access (RA) report (Block S136).

FIG. 21 is a flowchart of an exemplary process in a wireless device 22 according to some embodiments of the present disclosure. One or more blocks described herein may be performed by one or more elements of wireless device 22 such as by one or more of processing circuitry 84 (including the preamble selector unit 34), processor 86, radio interface 82 and/or communication interface 60. Wireless device 22 such as via processing circuitry 84 and/or processor 86 and/or radio interface 82 is configured to receive preamble group information in a random access (RA) report (Block S138). The process includes selecting a preamble group based at least in part on the preamble group information (Block S140).

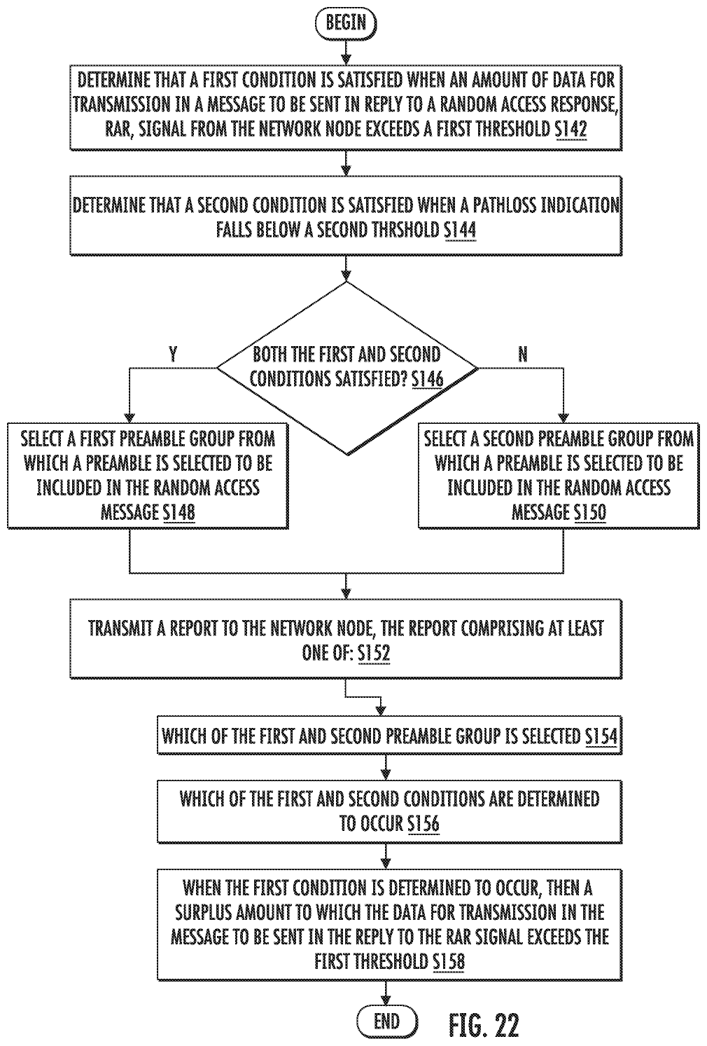

FIG. 22 is a flowchart of an exemplary process in a wireless device 22 according to some embodiments of the present disclosure. One or more blocks described herein may be performed by one or more elements of wireless device 22 such as by one or more of processing circuitry 84 (including the preamble selector unit 34), processor 86, radio interface 82 and/or communication interface 60. Wireless device 22 such as via processing circuitry 84 and/or processor 86 and/or radio interface 82 is configured to determine that a first condition is satisfied when an amount of data for transmission in a message to be sent in reply to a random access response, RAR, signal from the network node exceeds a first threshold (Block S142). The process also includes determining a that a second condition is satisfied when a pathloss indication falls below a second threshold (Block S144). The process further includes, when both the first and second conditions are satisfied (Block S146), selecting a first preamble group from which a preamble is selected to be included in a random access message (Block S148). Otherwise, a second preamble group is selected from which a preamble is selected to be included in the random access message (Block S150). The process also includes transmitting a report to the network node, the report comprising at least one of (Block S152): which of the first and second preamble group is selected (Block S154); which of the first and second conditions are determined to occur (Block S156); and when the first condition is satisfied, then, a surplus amount to which the data for transmission in the message to be sent in the reply to the RAR signal exceeds the first threshold (Block S158).

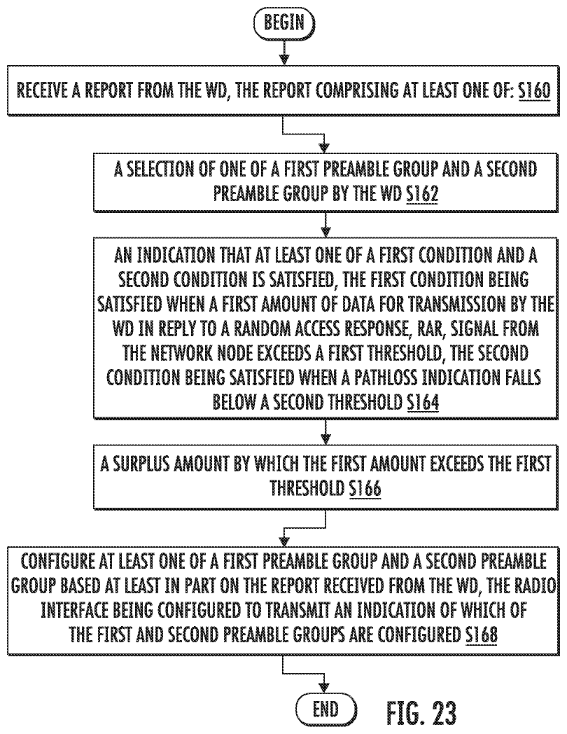

FIG. 23 is a flowchart of an exemplary process in a network node 16 for inclusion of preamble group information in a random access (RA) report. One or more blocks described herein may be performed by one or more elements of network node 16 such as by one or more of processing circuitry 68 (including the preamble group configuration unit 32), processor 70, radio interface 62 and/or communication interface 60. Network node 16 such as via processing circuitry 68 and/or processor 70 and/or radio interface 62 and/or communication interface 60 is configured to receive a report from the WD, the report comprising at least one of (Block S160): a selection of one of a first preamble group and a second preamble group by the WD (Block S162); an indication that at least one of a first condition and a second condition is satisfied, the first condition being satisfied when a first amount of data for transmission by the WD in reply to a random access response, RAR, signal from the network node exceeds a first threshold, the second condition being satisfied when a pathloss indication falls below a second threshold (Block S164); and a surplus amount by which the first amount exceeds the first threshold (Block S166). The process further includes configuring least one of a first preamble group and a second preamble group based at least in part on the report received from the WD, the radio interface being configured to transmit an indication of which of the first and second preamble groups are configured (Block S168).

Having described the general process flow of arrangements of the disclosure and having provided examples of hardware and software arrangements for implementing the processes and functions of the disclosure, the sections below provide details and examples of arrangements for inclusion of preamble group information in a random access (RA) report.

Some embodiments address the above described problem by including preamble group related information in, for example, the RA-Report information element (IE) in the WDInformationResponse message.

The network, e.g., via network node 16, may divide the preambles available for contention-based random access in a cell into two preamble groups: group A and group B. If both 2-step RA and 4-step RA are supported in the cell/BWP, then this division if performed for both RA types, i.e. if shared PRACH occasions are used between 2-step RA and 4-step RA, then the preambles are divided in to a set of preambles for 2-step RA and a set of preambles for 4-step RA and each of those sets are then further divided into a preamble group A and a preamble group B.

Two conditions should be fulfilled for selection of preamble group B:
The amount of data available for transmission in Msg3 (for 4-step RA) or MsgA PUSCH (for 2-step RA) should be greater than a configured threshold (ra-Msg3SizeGroupA for 4-step RA and ra-MsgA-SizeGroupA for 2-step RA); and
The WD's 22 experienced pathloss should be lower than a threshold value, for example, as calculated according to a formula specified in 3GPP TS 38.321.

If any of these conditions is not fulfilled, the WD may select preamble group A.

A first piece of information that may be included as per RA attempt information in the RA-Report is an indication of whether the WD selected a preamble from preamble group A or B. The network, e.g., via network node 16, may use this information to optimize the division of the contention-based preambles into group A and B and, in case of 2-step RA, the associated MsgA PUSCH configuration.

Furthermore, as stated above, the WD's choice between preamble group A and B may depend on two conditions related to two different properties. The optimizing actions, e.g., reconfigurations, the network can choose to perform can depend on both these properties. Therefore, the reason that caused a WD 22 to select a certain preamble group may be important for the network to know. For instance, if the WD 22 selected a 4-step preamble from preamble group A because of a pathloss that is too large, even though the amount of data available for transmission in Msg3 was greater than ra-Msg3SizeGroupA, or if the WD selected a 2-step RA preamble from preamble group A because of too large a pathloss, even though the amount of data available for transmission in MsgA PUSCH was greater than ra-MsgA-SizeGroupA, then the network node 16, may attempt to change the preambleReceivedTargetPower or the msgA-PreambleReceivedTargetPower parameter or both. Otherwise, if the amount of data available for Msg3 or MsgA PUSCH transmission was smaller than ra-Msg3SizeGroupA or ra-MsgA-SizeGroupA and the pathloss was small, this may be an indication to the network node 16, to reduce the number of preambles in preamble group B (or even completely remove preamble group B).

Therefore, as a second piece of information, the WD 22 may, as one option in accordance with the proposed solution, include in the RA-Report an indication of the reason for selection of the selected preamble group for each RA attempt.

Furthermore, to aid the network to optimize the size of the uplink transmission resource allocations for Msg3 and/or MsgA PUSCH associated with preamble group A and B, respectively, it may be beneficial for the network to know how much, if any, data the WD 22 had available for uplink transmission that it could not fit into Msg3 or MsgA PUSCH. This information may be provided by the WD 22 per RA procedure in the RA-Report, but another option is to include the information per RA attempt (which may be beneficial to reflect any changes in the amount of available data between RA attempts).

However, the size of the uplink transmission resource allocation associated with preamble group A is typically tailored for transmission of the RRC messages RRCSetupRequest and RRCResumeRequest (and/or RRCResumeRequest1). Hence, the size of any available data that did not fit into Msg3 or MsgA PUSCH may be of less interest to the network when preamble group A is selected than when preamble group B is selected. Therefore, as one option, the WD 22 may include information about how much, if any, data the WD 22 had available for uplink transmission that it could not fit into Msg3 or MsgA PUSCH only if the WD selected a preamble from preamble group B.

As another option, the WD 22 may include the above described information only if both preamble group A and B are configured in the concerned cell/BWP.

As yet another option, if only preamble group B is configured in the cell/BWP, the WD 22 may include only the information about how much, if any, data the WD 22 had available for uplink transmission that it could not fit into the allocated uplink transmission resources for Msg3.

In some embodiments, the WD 22 may include information related to the preamble group selection when it transmits an RA-Report to the network in a WDInformationResponse message. This information may include:
Selected preamble group;
Reason for the selection of the selected preamble group; and/or
The amount of data the WD 22 had available for transmission in Msg3 or MsgA PUSCH that did not fit into the allocated uplink transmission resources for Msg3 or MsgA PUSCH.

According to one aspect, a WD 22 is configured to wirelessly communicate with a network node 16 by engaging in a random access procedure. The WD 22 includes processing circuitry 84 configured to: determine that a first condition is satisfied when an amount of data for transmission in a message to be sent in reply to a random access response, RAR, signal from the network node 16 exceeds a first threshold; determine that a second condition is satisfied when a pathloss indication falls below a second threshold. When both the first and second conditions are satisfied, the processing circuitry 84 is configured to select a first preamble group from which a preamble is selected to be included in a random access message. Otherwise, the processing circuitry 84 is configured to select a second preamble group from which a preamble is selected to be included in the random access message. The WD 22 also includes a radio interface 82 in communication with the processing circuitry 84 and configured to transmit a report to the network node 16, the report comprising at least one of: which of the first and second preamble group is selected; which of the first and second conditions are determined to occur; and when the first condition is determined to occur, then a surplus amount to which the data for transmission in the message to be sent in the reply to the RAR signal exceeds the first threshold.

According to this aspect, in some embodiments, the message is a Msg3 of a four-step random access procedure. In some embodiments, the message is a MsgA of a two-step random access procedure. In some embodiments, the surplus amount is reported to the network node 16 only when the first preamble group is selected. In some embodiments, only the surplus amount is reported to the network node 16 when only the first preamble group is selected.

According to another aspect, a method for a wireless device, WD 22, to wirelessly communicate with a network node 16 by engaging in a random access procedure is provided. The method includes: determining that a first condition is satisfied when an amount of data for transmission in a message to be sent in reply to a random access response, RAR, signal from the network node 16 exceeds a first threshold; determining a that a second condition is satisfied when a pathloss indication falls below a second threshold; and when both the first and second conditions are satisfied, selecting a first preamble group from which a preamble is selected to be included in a random access message; otherwise selecting a second preamble group from which a preamble is selected to be included in the random access message. The method also includes transmitting a report to the network node 16, the report comprising at least one of: which of the first and second preamble group is selected; which of the first and second conditions are determined to occur; and when the first condition is satisfied, then, a surplus amount to which the data for transmission in the message to be sent in the reply to the RAR signal exceeds the first threshold.

According to this aspect, in some embodiments, the message is a Msg3 of a four-step random access procedure. In some embodiments, the message is a MsgA of a two-step random access procedure. In some embodiments, the method also includes reporting the surplus amount to the network node 16 only when the first preamble group is selected. In some embodiments, the method also includes reporting only the surplus amount to the network node 16 when only the first preamble group is selected.

According to another aspect, a network node 16 is configured to wirelessly communicate with a wireless device, WD 22, by engaging in a random access procedure. The network node 16 includes a radio interface 62 configured to receive a report from the WD 22, the report comprising at least one of: a selection of one of a first preamble group and a second preamble group by the WD 22; an indication that at least one of a first condition and a second condition is satisfied, the first condition being satisfied when a first amount of data for transmission by the WD 22 in reply to a random access response, RAR, signal from the network node 16 exceeds a first threshold, the second condition being satisfied when a pathloss indication falls below a second threshold; and a surplus amount by which the first amount exceeds the first threshold. The network node 16 also includes processing circuitry 68 in communication with the radio interface 62 and configured to configure at least one of a first preamble group and a second preamble group based at least in part on the report received from the WD 22, the radio interface being configured to transmit an indication of which of the first and second preamble groups are configured.

According to this aspect, in some embodiments, when the report does not indicate that the second condition is satisfied and indicates that the first condition is satisfied, then the processing circuitry is further configured to increase a preamble target power parameter. In some embodiments, when the report does not indicate that the first condition is satisfied and indicates that the second condition is satisfied, then the processing circuitry 68 is configured to reduce a number of preambles in the first preamble group. In some embodiments, both the first preamble group and the second preamble group are configured when the report does not indicate that the first condition is satisfied and does not indicate that the second condition is satisfied. In some embodiments, when the report indicates that the first preamble is selected, the processing circuitry is configured to configure only the first preamble group based at least in part on the surplus amount.

According to yet another aspect, in some embodiments, a method in a network node 16 for wirelessly communicating with a wireless device, WD 22, by engaging in a random access procedure is provided. The network node 16 includes receiving a report from the WD 22, the report comprising at least one of: a selection of one of a first preamble group and a second preamble group by the WD 22; an indication that at least one of a first condition and a second condition is satisfied, the first condition being satisfied when a first amount of data for transmission by the WD 22 in reply to a random access response, RAR, signal from the network node 16 exceeds a first threshold, the second condition being satisfied when a pathloss indication falls below a second threshold; and a surplus amount by which the first amount exceeds the first threshold. The method also includes configuring at least one of a first preamble group and a second preamble group based at least in part on the report received from the WD 22, the radio interface being configured to transmit an indication of which of the first and second preamble groups are configured.

According to this aspect, in some embodiments, the method also includes, when the report does not indicate that the second condition is satisfied and indicates that the first condition is satisfied, increasing a preamble target power parameter. In some embodiments, the method also includes, when the report does not indicate that the first condition is satisfied and indicates that the second condition is satisfied, reducing a number of preambles in the first preamble group. In some embodiments, both the first preamble group and the second preamble group are configured when the report does not indicate that the first condition is satisfied and does not indicate that the second condition is satisfied. In some embodiments, the method further includes, when the report indicates that the first preamble is selected, configuring only the first preamble group based at least in part on the surplus amount.

According to one aspect, a network node 16 is configured to communicate with a wireless device (WD) 22. The network node 16 includes a radio interface 62 and/or comprising processing circuitry 68 configured to divide preambles available for contention based random access (RA) in a cell into two preamble groups and transmit preamble group information in a random access (RA) report. Of note, although embodiments herein are described with respect to the use of two preamble groups, it is understood that implementations are not limited to two preamble groups. The concepts and embodiments provided herein can be extended to multiple preamble groups in excess of two groups.

According to this aspect, in some embodiments, one preamble group of the two preamble groups is selected based at least in part on an amount of data available for transmission. In some embodiments, one preamble group of the two preamble groups is selected based at least in part on a path loss experienced by the WD 22. In some embodiments, one preamble group of the two preamble groups is for 2-step random access and the other preamble group of the two preamble groups is for 4-step random access.

According to another aspect, a method implemented in a network node 16 includes dividing preambles available for contention based random access (RA) in a cell into two preamble groups, and transmitting preamble group information in a random access (RA) report.

According to this aspect, in some embodiments, one preamble group of the two preamble groups is selected based at least in part on an amount of data available for transmission. In some embodiments, one preamble group of the two preamble groups is selected based at least in part on a path loss experienced by the WD 22. In some embodiments, one preamble group of the two preamble groups is for 2-step random access and the other preamble group of the two preamble groups is for 4-step random access.

According to yet another aspect, a WD 22 is configured to communicate with a network node 16. The WD 22 includes a radio interface 82 and/or processing circuitry 84 configured to receive preamble group information in a random access (RA) report, and select a preamble group based at least in part on the preamble group information.

According to this aspect, in some embodiments, a preamble group is selected based at least in part on an amount of data available for transmission. In some embodiments, a preamble group is selected based at least in part on a path loss experienced by the WD 22.

According to another aspect, a method implemented in a wireless device (WD) includes receiving preamble group information in a random access (RA) report and selecting a preamble group based at least in part on the preamble group information.

According to this aspect, in some embodiments, a preamble group is selected based at least in part on an amount of data available for transmission. In some embodiments, a preamble group is selected based at least in part on a path loss experienced by the WD 22.

Some embodiments may include one or more of the following:

Embodiment A1. A network node configured to communicate with a wireless device (WD), the network node configured to, and/or comprising a radio interface and/or comprising processing circuitry configured to:
divide preambles available for contention based random access (RA) in a cell into two preamble groups; and
transmit preamble group information in a random access (RA) report.

Embodiment A2. The network node of Embodiment A1, wherein one preamble group of the two preamble groups is selected based at least in part on an amount of data available for transmission.

Embodiment A3. The network node of Embodiment A1, wherein one preamble group of the two preamble groups is selected based at least in part on a path loss experienced by the WD.

Embodiment A4. The network node of Embodiment A1, wherein one preamble group of the two preamble groups is for 2-step random access and the other preamble group of the two preamble groups is for 4-step random access.

Embodiment B1. A method implemented in a network node, the method comprising
dividing preambles available for contention based random access (RA) in a cell into two preamble groups; and
transmitting preamble group information in a random access (RA) report.

Embodiment B2. The method of Embodiment B1, wherein one preamble group of the two preamble groups is selected based at least in part on an amount of data available for transmission.

Embodiment B3. The method of Embodiment B1, wherein one preamble group of the two preamble groups is selected based at least in part on a path loss experienced by the WD.

Embodiment B4. The method of Embodiment B1, wherein one preamble group of the two preamble groups is for 2-step random access and the other preamble group of the two preamble groups is for 4-step random access.

Embodiment C1. A wireless device (WD) configured to communicate with a network node, the WD configured to, and/or comprising a radio interface and/or processing circuitry configured to: receive preamble group information in a random access (RA) report; and
select a preamble group based at least in part on the preamble group information.

Embodiment C2. The WD of Embodiment C1, wherein a preamble group is selected based at least in part on an amount of data available for transmission.

Embodiment C3. The WD of Embodiment C1, wherein a preamble group is selected based at least in part on a path loss experienced by the WD.

Embodiment D1. A method implemented in a wireless device (WD), the method comprising
receiving preamble group information in a random access (RA) report; and
selecting a preamble group based at least in part on the preamble group information.

Embodiment D2. The method of Embodiment D1, wherein a preamble group is selected based at least in part on an amount of data available for transmission.

Embodiment D3. The method of Embodiment D1, wherein a preamble group is selected based at least in part on a path loss experienced by the WD.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | 3^{rd} Generation Partnership Project |
| BWP | Bandwidth Part |
| CCO | Coverage Capacity Optimization |
| CE | Control Element |
| C-RNTI | Cell specific RNTI |
| DL | Downlink |
| gNB | Radio base station in NR. |
| LTE | Long Term Evolution |
| MAC | Medium Access Control |
| MCS | Modulation and Coding Scheme |
| Msg | Message |
| NR | New Radio |
| PDCCH | Physical Downlink Control Channel |
| PDSCH | Physical Downlink Shared Channel |
| PRACH | Physical Random Access Channel |
| PUSCH | Physical Uplink Shared Channel |
| RA | Random Access |
| RACH | Random Access Channel |
| RA-RNTI | Random Access RNTI |
| RNTI | Radio Network Temporary Identity |
| RRC | Radio Resource Control |
| SON | Self-Optimizing Network |
| TC-RNTI | Temporary C-RNTI |
| UE | User Equipment |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to wirelessly communicate with a network node by engaging in a random access procedure, the WD comprising:
processing circuitry configured to:
determine that a first condition is satisfied when an amount of data for transmission in a message to be sent in reply to a random access response, RAR, signal from the network node exceeds a first threshold;
determine that a second condition is satisfied when a pathloss indication falls below a second threshold; and
when both the first and second conditions are satisfied, select a first preamble group from which a preamble is selected to be included in a random access message; and
otherwise select a second preamble group from which a preamble is selected to be included in the random access message; and
a radio interface in communication with the processing circuitry and configured to transmit a report to the network node, the report comprising at least one of:
which of the first and second preamble group is selected;
which of the first and second conditions are determined to occur; and
when the first condition is determined to occur, then a surplus amount to which the data for transmission in the message to be sent in the reply to the RAR signal exceeds the first threshold.

2. The WD of claim 1, wherein the message is a Msg3 of a four-step random access procedure.

3. The WD of claim 1, wherein the message is a MsgA of a two-step random access procedure.

4. The WD of claim 1, wherein the surplus amount is reported to the network node only when the first preamble group is selected.

5. The WD of claim 1, wherein only the surplus amount is reported to the network node when only the first preamble group is selected.

6. A method for a wireless device, WD, to wirelessly communicate with a network node by engaging in a random access procedure, the method comprising:
determining that a first condition is satisfied when an amount of data for transmission in a message to be sent in reply to a random access response, RAR, signal from the network node exceeds a first threshold;
determining a that a second condition is satisfied when a pathloss indication falls below a second threshold; and
when both the first and second conditions are satisfied, selecting a first preamble group from which a preamble is selected to be included in a random access message;
otherwise selecting a second preamble group from which a preamble is selected to be included in the random access message; and
transmitting a report to the network node, the report comprising at least one of:
which of the first and second preamble group is selected;
which of the first and second conditions are determined to occur; and
when the first condition is satisfied, then, a surplus amount to which the data for transmission in the message to be sent in the reply to the RAR signal exceeds the first threshold.

7. The method of claim 6, wherein the message is a Msg3 of a four-step random access procedure.

8. The method of claim 6, wherein the message is a MsgA of a two-step random access procedure.

9. The method of claim 6, further comprising reporting the surplus amount to the network node only when the first preamble group is selected.

10. The method of claim 6, further comprising reporting only the surplus amount to the network node when only the first preamble group is selected.

11. A network node configured to wirelessly communicate with a wireless device, WD, by engaging in a random access procedure, the network node comprising:
a radio interface configured to receive a report from the WD, the report comprising at least one of:
a selection of one of a first preamble group and a second preamble group by the WD;
an indication that at least one of a first condition and a second condition is satisfied, the first condition being satisfied when a first amount of data for transmission by the WD in reply to a random access response, RAR, signal from the network node exceeds a first threshold, the second condition being satisfied when a pathloss indication falls below a second threshold; and
a surplus amount by which the first amount exceeds the first threshold; and
processing circuitry in communication with the radio interface and configured to configure at least one of a first preamble group and a second preamble group based at least in part on the report received from the WD, the radio interface being configured to transmit an indication of which of the first and second preamble groups are configured.

12. The network node of claim 11, wherein, when the report does not indicate that the second condition is satisfied and indicates that the first condition is satisfied, then the processing circuitry is further configured to increase a preamble target power parameter.

13. The network node of claim 11, wherein, when the report does not indicate that the first condition is satisfied and indicates that the second condition is satisfied, then the processing circuitry is configured to reduce a number of preambles in the first preamble group.

14. The network node of claim 11, wherein both the first preamble group and the second preamble group are configured when the report does not indicate that the first condition is satisfied and does not indicate that the second condition is satisfied.

15. The network node of claim 11, wherein, when the report indicates that the first preamble is selected, the processing circuitry is configured to configure only the first preamble group based at least in part on the surplus amount.

16. A method in a network node for wirelessly communicating with a wireless device, WD, by engaging in a random access procedure, the method comprising:
receiving a report from the WD, the report comprising at least one of:
a selection of one of a first preamble group and a second preamble group by the WD;
an indication that at least one of a first condition and a second condition is satisfied, the first condition being satisfied when a first amount of data for transmission by the WD in reply to a random access response, RAR, signal from the network node exceeds a first threshold, the second condition being satisfied when a pathloss indication falls below a second threshold; and
a surplus amount by which the first amount exceeds the first threshold; and
configuring at least one of a first preamble group and a second preamble group based at least in part on the report received from the WD, the radio interface being configured to transmit an indication of which of the first and second preamble groups are configured.

17. The method of claim 16, further comprising, when the report does not indicate that the second condition is satisfied and indicates that the first condition is satisfied, increasing a preamble target power parameter.

18. The method of claim 16, further comprising, when the report does not indicate that the first condition is satisfied and indicates that the second condition is satisfied, reducing a number of preambles in the first preamble group.

19. The method of claim 16, wherein both the first preamble group and the second preamble group are configured when the report does not indicate that the first condition is satisfied and does not indicate that the second condition is satisfied.

20. The method of claim 16, further comprising, when the report indicates that the first preamble is selected, configuring only the first preamble group based at least in part on the surplus amount.
